(19) United States
(12) Patent Application Publication
(10) Pub. No.: US 2025/0053891 A1
(43) Pub. Date: Feb. 13, 2025

(54) DELIVERY MATCHING SYSTEM AND DELIVERY MATCHING METHOD

(71) Applicant: Hitachi, Ltd., Tokyo (JP)

(72) Inventors: Toru FUJIHIRA, Tokyo (JP); Tadayoshi KOSAKA, Tokyo (JP); Naoki FURUYA, Tokyo (JP); Manabu HASEGAWA, Tokyo (JP); Kazuya UYAMA, Tokyo (JP)

(21) Appl. No.: 18/744,760

(22) Filed: Jun. 17, 2024

(30) Foreign Application Priority Data
Aug. 7, 2023 (JP) 2023-128811

(51) Int. Cl. G06Q 10/047; G06N 3/08; G06Q 10/0835

(52) U.S. Cl. CPC G06Q 10/047; G06N 3/08; G06Q 10/08355

(57) ABSTRACT

A predetermined learning model is learned using an index value for a selected solution, which is a Pareto solution selected by a user among Pareto solutions based on a predetermined index, obtained from past input data including a combination of a delivery route and an additional delivery order, as training data, current input data including the combination is input to the learned predetermined learning model, a prediction index weight vector for each index of the Pareto solution is calculated, a Pareto solution in which a degree of similarity with the prediction index weight vector satisfies a predetermined condition is specified among the Pareto solutions, and the specified Pareto solution is output.

### CROSS-REFERENCE TO RELATED APPLICATION

The present application claims priority from Japanese application JP2023-128811, filed on Aug. 7, 2023, the content of which is hereby incorporated by reference into this application.

### BACKGROUND OF THE INVENTION

### 1. Field of the Invention

The present invention relates to a delivery matching system and a delivery matching method.

### 2. Description of the Related Art

From the related art, in the delivery business, a need to improve an efficiency through cooperative delivery of plurality of delivery companies and cargo owners has increased in response to a shortage of drivers or energy saving.

Therefore, a technology is known in which a search for cargos and a search for vehicles are matched by a multi-objective optimization method considering a plurality of indices such as the total movement distance of a vehicle such as a truck and revenue fairness of the delivery companies.

For example, in JP 2002-288625 A, “including (a) a step of providing a neural network 20, (b) a step of applying a plurality of input data pieces x1 and x2 relevant to a multi-objective optimization problem to the neural network, (c) a step of performing the learning of the neural network as the result of (b), and (d) a step of obtaining the neural network approximating a preference function in the multi-objective optimization problem as the result of (c)” is described.

In the optimization of the plurality of indices, a trade-off relationship between the indices easily occurs. Therefore, Pareto solutions with different balances between the plurality of indices are derived by a multi-objective optimization method using a genetic algorithm or the like in addition to single indexing by weighting, and then, a user selects a solution from the Pareto solutions by considering the balance between the indices. In JP 2002-288625 A, an evaluation index value xi of the solution selected by the multi-objective optimization is input, and a subjective evaluation value (a numerical value indicating superiority or inferiority) of the user with respect to the solution is learned as training data by the neural network. However, it is considered that the user selects the solution by determining a relative relationship between the solutions from the index value distribution shape of the entire solution set, but in this technology, since learning is performed by inputting a single solution, it is not possible to consider the relative relationship between the solutions.

As a result thereof, in a case where there are many evaluation indices of the multi-objective optimization, a ratio of a solution superior to other solutions (that is, inferior in all the indices) decreases, and thus, the Pareto solution increases (for example, approximately 100 in 5 indices), and an operation for the user to select the solution becomes complicated. In addition, there are many cases where the user implicitly determines the solution by considering the balance (weight) between the indices when selecting the solution, and thus, the weight is changed by the user. Further, the weight between the indices is changed in accordance with the distribution state of the index values of all the Pareto solutions. For example, basically, in a case where a difference in the cost index between the solutions is small to a certain extent, it is considered that the user prioritizing the cost selects a solution with superior fairness even when the cost is inferior in a range allowable by the user. Alternatively, since it is considered to prioritize a driver burden index as time until the delivery is shortened, it is not possible to determine the Pareto solution by fixed weight between the indices. Therefore, there has been a need for a technology in which a user preference solution considering an index emphasized by the user is selected from a plurality of optimum solutions, in accordance with the distribution state of the index value, in optimization calculation in a case where there are a plurality of indices.

### SUMMARY OF THE INVENTION

An object of the invention is to provide a technology in which a user preference solution considering an index emphasized by a user can be selected from a plurality of optimum solutions, in accordance with a distribution state of an index value, in optimization calculation in a case where there are a plurality of indices.

A delivery matching system according to the invention is configured as a delivery matching system allocating an additional order for delivering a cargo to an existing delivery route by a computer including a processor and a memory, in which the processor performs learning of a predetermined learning model using an index value for a selected solution, which is a Pareto solution selected by a user among Pareto solutions based on a predetermined index, obtained from past input data including a combination of a delivery route and an additional delivery order, as training data, inputs current input data including the combination to the learned predetermined learning model, and calculates a prediction index weight vector for each index of the Pareto solution, specifies a Pareto solution in which a degree of similarity with the prediction index weight vector satisfies a predetermined condition, among the Pareto solutions, and outputs the specified Pareto solution.

According to the invention, it is possible to select the user preference solution considering the index emphasized by the user, from the plurality of optimum solutions, in accordance with the distribution state of the index value, in the optimization calculation in a case where there are the plurality of indices. As a result thereof, it is possible to reduce a cost required for an operation in which the user selects the user preference solution from the plurality of optimum solutions. Problems, configurations, and effects other than the above will be apparent by the following description of a mode for carrying out the invention.

### BRIEF DESCRIPTION OF THE DRAWINGS

FIG. 1 is a diagram illustrating an example of a configuration of a delivery matching system in this example;

FIG. 2 is a diagram illustrating a schematic example of a computer;

FIG. 3A is a diagram illustrating an example of input data received by this system;

FIG. 3B is a diagram for illustrating an example of a Pareto solution between indices output by a multi-objective optimization unit;

FIG. 3C is a diagram for illustrating a prediction index weight vector output by an index weight prediction unit using a learning model learned by an index weight learning unit;

FIG. 4 is a diagram illustrating an example of a cargo owner master table;

FIG. 5 is a diagram illustrating an example of a delivery company master table;

FIG. 6 is a diagram illustrating an example of a hub master table;

FIG. 7 is a diagram illustrating an example of additional order data;

FIG. 8 is a diagram illustrating an example of existing route data;

FIG. 9 is a diagram illustrating an example of matched route data;

FIG. 10 is a diagram illustrating an example of solution set index data;

FIG. 11 is a diagram illustrating an example of learning data;

FIG. 12 is a diagram illustrating an example of training data;

FIG. 13A is a flowchart illustrating an example of a processing procedure of delivery matching processing performed by this system;

FIG. 13B is a flowchart illustrating another example of the processing procedure of the delivery matching processing performed by this system;

FIG. 14 is a flowchart illustrating an example of a processing procedure of index value normalization processing;

FIG. 15A is a flowchart illustrating an example of a processing procedure of index weight prediction processing;

FIG. 15B is a flowchart illustrating another example of the processing procedure of the index weight prediction processing;

FIG. 16 is a flowchart illustrating an example of a processing procedure of solution recommendation processing;

FIG. 17 is a diagram for illustrating a method for calculating the degree of cosine similarity;

FIG. 18A is a diagram illustrating an example of total index data;

FIG. 18B is a diagram illustrating an example of a screen for a user to select an index;

FIG. 19 is a flowchart illustrating an example of a processing procedure of solution selection processing;

FIG. 20 is a diagram illustrating an example of a distribution of each index value of a selected Pareto solution (user preference solution), output in step 1905;

FIG. 21 is a diagram illustrating an example of a delivery route corresponding to the selected Pareto solution (user preference solution), output in step 1906 (the entire route);

FIG. 22 is a diagram illustrating an example of the delivery route corresponding to the selected Pareto solution (user preference solution), output in step 1906 (an individual route);

FIG. 23 is a diagram illustrating an example of the entire process flow of the delivery matching processing;

FIG. 24 is an explanatory diagram relevant to selection of a Pareto solution that is matched with preference of a delivery company; and

FIG. 25 is an explanatory diagram relevant to fitting of the prediction index weight vector in each delivery company.

### DETAILED DESCRIPTION OF THE PREFERRED EMBODIMENTS

Hereinafter, an embodiment of the invention will be described with reference to the drawings. The following description and drawings are illustrative for describing the invention, and are suitably omitted and simplified for the clarification of the description. The invention can also be implemented in various other forms. Unless specifically limited, each constituent may be singular or plural.

The position, the size, the shape, the range, and the like of each constituent illustrated in the drawings may not represent the actual size, shape, range, and the like, in order to facilitate the understanding of the invention. Accordingly, the invention is not necessarily limited to the position, the size, the shape, the range, and the like disclosed in the drawings.

In the following description, various information pieces may be described by expressions such as a “database”, a “table”, and a “list”, but various information pieces may be expressed by other data structures. An “XX table”, an “XX list”, and the like may be referred to as “XX information” to indicate independence on the data structure. In the case of using expressions such as “identification information”, an “identifier”, a “name”, an “ID”, and a “number” when describing identification information, such expressions can be replaced with each other.

In a case where there are a plurality of constituents having the same or similar functions, the constituents will be described by applying different suffixes to the same reference numerals. However, in a case where it is not necessary to distinguish the plurality of constituents, the constituents may be described by omitting the suffixes.

In addition, in the following description, processing performed by executing a program may be described, but the program is executed by a processor (for example, a CPU or a graphics processing unit (GPU)) to perform predetermined processing while suitably using memory resources (for example, a memory) and/or an interface device (for example, a communication port), and thus, the subject of the processing may be the processor. Similarly, the subject of the processing performed by executing the program may be a controller, a device, a system, a computer, or a node including the processor. The subject of the processing performed by executing the program may be an arithmetic unit, and may include a dedicated circuit performing specific processing (for example, a field programmable gate array (FPGA) and an application specific integrated circuit (ASIC)).

The program may be installed in a device such as a computer from a program source. The program source, for example, may be a program distribution server or a computer-readable storage medium. In a case where the program source is the program distribution server, the program distribution server may include a processor and memory resources storing a distribution target program, and the processor of the program distribution server may distribute the distribution target program to another computer. In addition, in the following description, two or more programs may be attained as one program, or one program may be attained as two or more programs.

Hereinafter, one example of a delivery matching system and a delivery matching method according to this example will be described. In the system described below, machine learning is performed by using an index value of a solution set of a predetermined number of times of multi-objective optimization implemented and accumulated in the past as learning data, and using a vector of which the component is an index value of a user preference solution selected by a user for the solution set as training data. Then, by a created learning model, the vector of which the component is the index value of the user preference solution is predicted for a solution set of multi-objective optimization that is newly implemented, and among the solution set, a solution with a high degree of similarity between the vector of which the component is the index value of the user preference solution and a vector of which the component is an index value of a solution included in the solution set is presented to the user as a recommended solution.

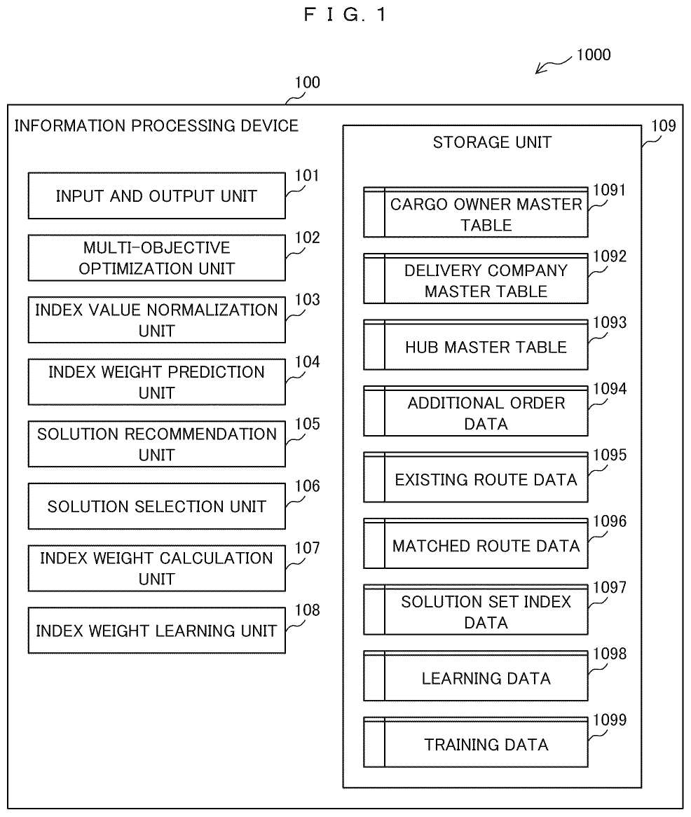

FIG. 1 is a diagram illustrating an example of the configuration of the delivery matching system in this example. As illustrated in FIG. 1, a delivery matching system 1000 includes an information processing device 100 for managing a delivery route, such as allocating an additional order to a delivery route of a cargo. The information processing device 100 is configured by including an input and output unit 101, a multi-objective optimization unit 102, an index value normalization unit 103, an index weight prediction unit 104, a solution recommendation unit 105, a solution selection unit 106, an index weight calculation unit 107, an index weight learning unit 108, a storage unit 109. The storage unit 109 stores a cargo owner master table 1091, a delivery company master table 1092, a hub master table 1093, additional order data 1094, existing route data 1095, matched route data 1096, solution set index data 1097, learning data 1098, and training data 1099.

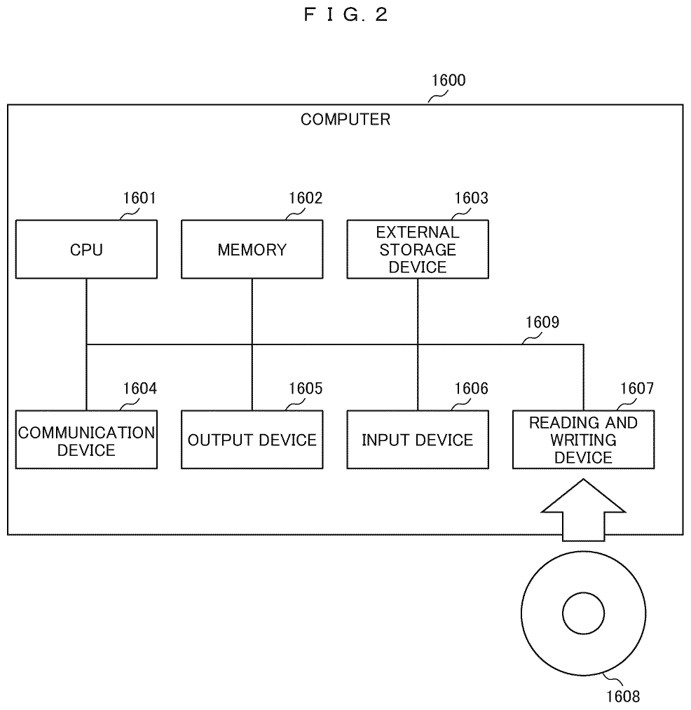

Specific processing of each unit of the information processing device 100 will be described below, but the information processing device 100, for example, can be attained by a general computer 1600 including an external storage device 1603 such as a CPU 1601, a memory 1602, a hard disk drive (HDD), a reading and writing device 1607 reading and writing information with respect to a storage medium 1608 having portability, such as a compact disk (CD) and a USB memory, an input device 1606 such as a keyboard, a mouse, and a microphone, an output device 1605 such as a display and a speaker, a communication device 1604 such as a network interface card (NIC) for connection with a communication network, an internal communication line (referred to as a system bus) 1609 such as a system bus linking the above, as illustrated in FIG. 2 (a computer schematic view).

In addition, various data pieces, which are stored in each terminal or each server or used for processing, can be attained by the CPU 1601 reading out the data from the memory 1602 or the external storage device 1603 to use the data. In addition, each function unit (for example, the input and output unit 101, the multi-objective optimization unit 102, the index value normalization unit 103, the index weight prediction unit 104, the solution recommendation unit 105, the solution selection unit 106, the index weight calculation unit 107, and the index weight learning unit 108) of the information processing device 100 can be attained by the CPU 1601 loading a predetermined program stored in the external storage device 1603 on the memory 1602 to execute the program. The predetermined program described above may be stored (downloaded) in an external storage device 1603 from the storage medium 1608 via the reading and writing device 1607 or from a network via the communication device 1604, and then, loaded on the memory 1602, and executed by the CPU 1601. In addition, the predetermined program may be directly loaded on the memory 1602 from the storage medium 1608 via the reading and writing device 1607 or from a network via the communication device 1604, and executed by the CPU 1601.

Hereinafter, a case where the information processing device 100 includes one computer will be exemplified, but all or a part of the functions may be provided by being distributed to one or a plurality of computers such as a cloud, and the same function may be attained by communication between the computers via a network.

The input and output unit 101 receives the input of the data used for the processing this system, which includes a delivery route or an additional delivery order, from the input device 1606, and outputs the result of the processing performed in this system to the output device 1605.

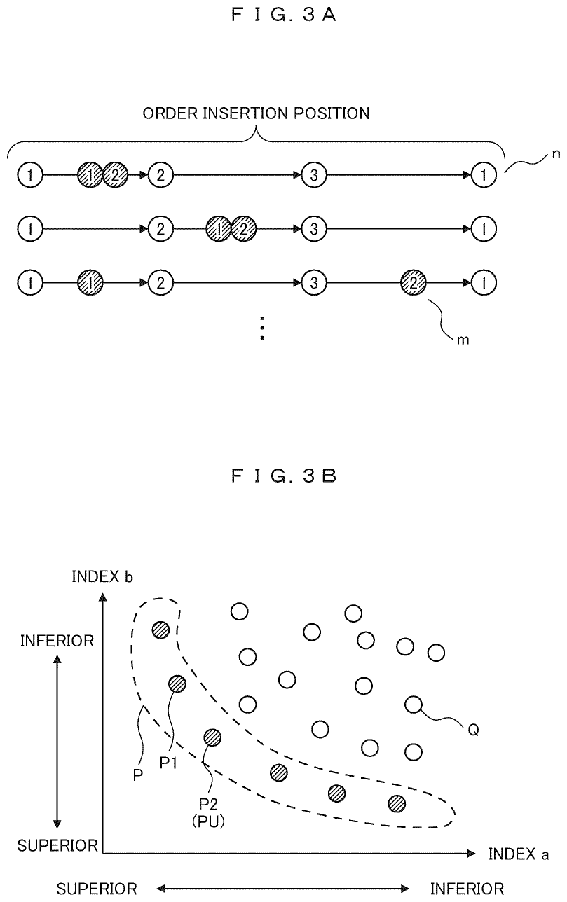

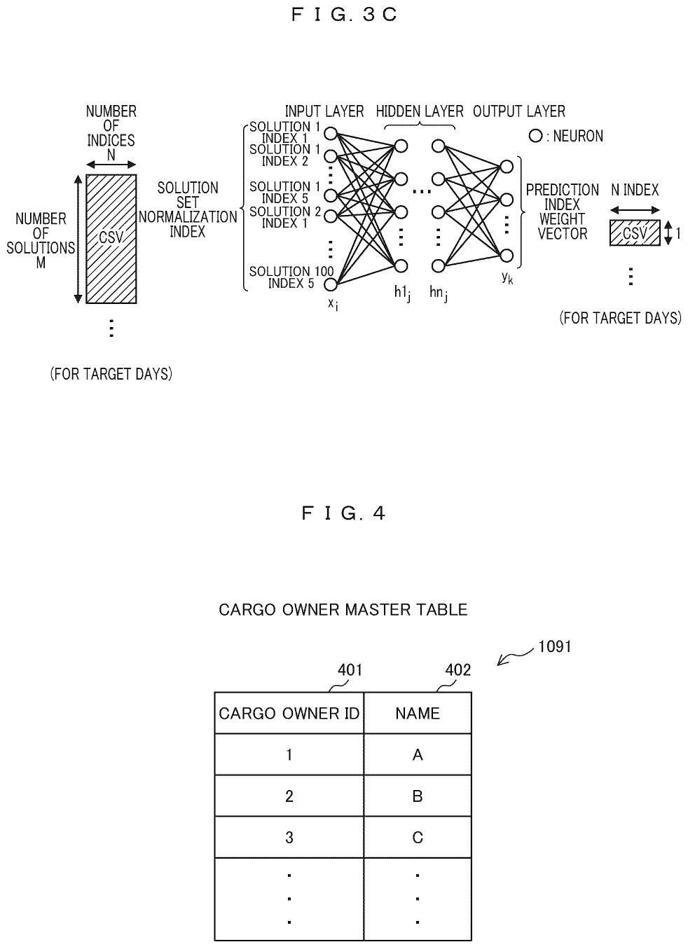

For example, a case where there are additional delivery orders 1 to m and delivery routes 1 to n is considered using FIG. 3A. In this example, there are two additional delivery orders m, and the delivery route n circulating three delivery hubs is illustrated. As a timing for receiving the delivery order m added on the delivery route n, a plurality of cases are considered, as illustrated at an order insertion position. The input and output unit 101 receives the input of input data including a combination of such delivery route and additional delivery order. A specific example of the result of the processing output by the input and output unit 101 will be described below.

The multi-objective optimization unit 102 outputs a predetermined number of Pareto solutions by a method such as a genetic algorithm and particle swarm optimization (PSO). In the optimization of a plurality of indices, a trade-off relationship between the indices easily occurs, and thus, the multi-objective optimization unit 102 derives Pareto solutions with different balances between the plurality of indices by using the method described above. The user selects a desired solution as the user preference solution from the Pareto solutions that are derived by the multi-objective optimization unit 102 considering the balance between the indices and output by the input and output unit 101.

For example, for a combination where the additional delivery order is allocated to the delivery route described above (in FIG. 3A, a combination of the additional delivery orders 1 and 2), and a combination of circulation orders for each combination (in FIG. 3A, a combination of insertion positions of the additional delivery orders 1 and 2), the multi-objective optimization unit 102 derives the Pareto solution between the indices regarding the following indices. The Pareto solution is a solution that is not superior to any other solutions (superior to other solutions in any index).

Specifically, the multi-objective optimization unit 102 calculates five evaluation indices such as 1. Total Movement Distance, 2. Distribution of Revenue, 3. Average of Vehicle Occupation Rate, 4. Compatibility of Cargo Owner with Delivery Company, and 5. Number of Operation Plan Change Sites, and derives the Pareto solution between the indices. The user determines in advance which index to use. In this example, for the total movement distance, the index is determined from the viewpoint of a cost, for the distribution of the revenue, the index is determined from the viewpoint of fairness, for the average of the vehicle occupation rate, the index is determined from the viewpoint of a delivery efficiency, for the compatibility between the delivery company and the cargo owner, the index is determined from the viewpoint of business custom, and for the number of operation plan change sites, the index is determined from the viewpoint of driver burden.

FIG. 3B is a diagram for illustrating an example of the Pareto solution between the indices output by the multi-objective optimization unit 102. In FIG. 3B, the Pareto solution output on a two-dimensional coordinate axis between the indices such as “1. Total Movement Distance” and “2. Distribution of Revenue” is illustrated, but practically, the Pareto solution is output for five indices described above.

As illustrated in FIG. 3B, the multi-objective optimization unit 102 calculates a Pareto solution P between the total movement distance (an index a) and the distribution of the revenue (an index b) using a method such as a genetic algorithm and PSO. From such Pareto solutions, the user selects the Pareto solution to be the user preference solution that is a solution considering an index emphasized by the user. For example, the user basically prioritizes the distance, and a difference in the total movement distance between Pareto solutions P1 and P2 is smaller than that between the other Pareto solutions, and a difference in the distribution of the revenue between the Pareto solutions P1 and P2 is larger than that between the other Pareto solutions. Therefore, the user selects the Pareto solution P2 as a Pareto solution PU to be the user preference solution described above. Note that, a solution Q is a solution having other solutions superior to all the indices. The multi-objective optimization unit 102 outputs the Pareto solution between the indices as the solution set index data 1097. An example of the solution set index data 1097 will be described below.

Each index, for example, can be calculated by the following method. For “1. Total Movement Distance”, the multi-objective optimization unit 102 is capable of performing calculation in a procedure such as (1) acquiring a state where the movement distance of a vehicle such as a truck=an Euclidean distance between a departure point (for example, a departure hub) and an arrival point (for example, an arrival hub) in which each vehicle moves, (2) summing up the movement distance of each vehicle on the delivery route=the Euclidean distance of (1) for all the movements of the vehicle, and (3) summing up a state where the total movement distance=the movement distance for each vehicle on the delivery route, which is calculated in (2), for all the vehicles (Equation 1).

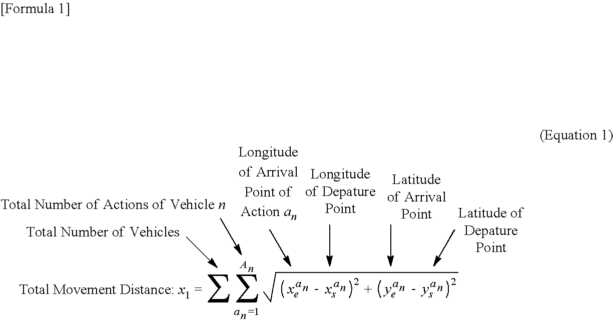

In addition, for “2. Distribution of Revenue”, the multi-objective optimization unit 102 is capable of performing calculation in a procedure such as (1) acquiring the Profit value of each vehicle on the delivery route, (2) acquiring the Profit average value of all the delivery routes, and (3) obtaining the square of a difference between (1) and (2), for each state where the distribution of the revenue=delivery route of each vehicle, to calculate the average value of all the vehicles on the delivery route (Equation 2).

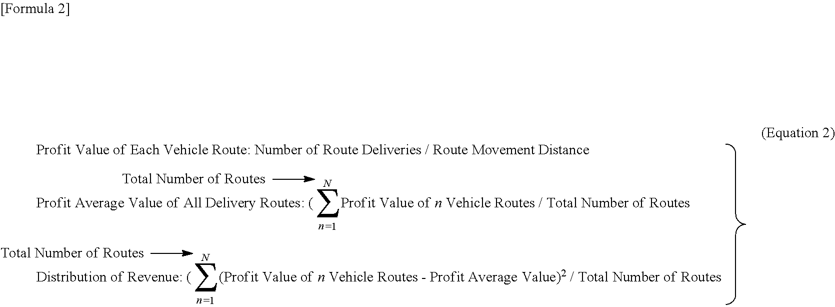

In addition, for “3. Average of Vehicle Occupation Rate”, the multi-objective optimization unit 102 is capable of performing calculation in a procedure such as (1) acquiring the movement distance of each vehicle on the delivery route, (2) acquiring the empty movement distance of each vehicle on the delivery route, (3) acquiring the vehicle occupation rate of each vehicle on the delivery route, and (4) calculating a state where the average of the vehicle occupation rate=the average of the vehicle occupation rates of all the vehicles on the delivery route (Equation 3).

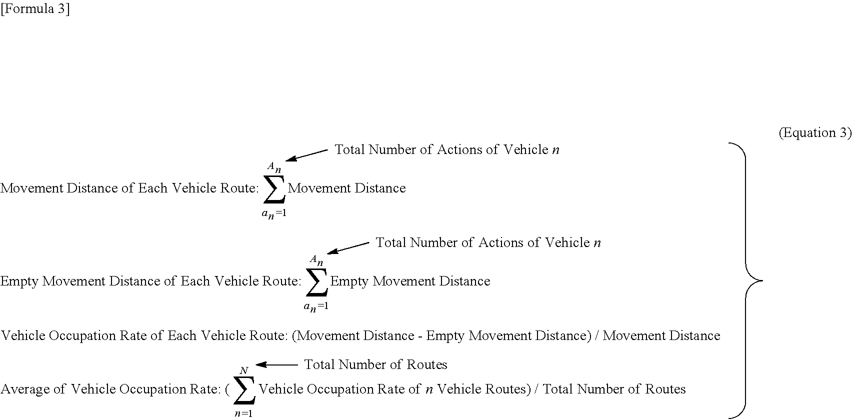

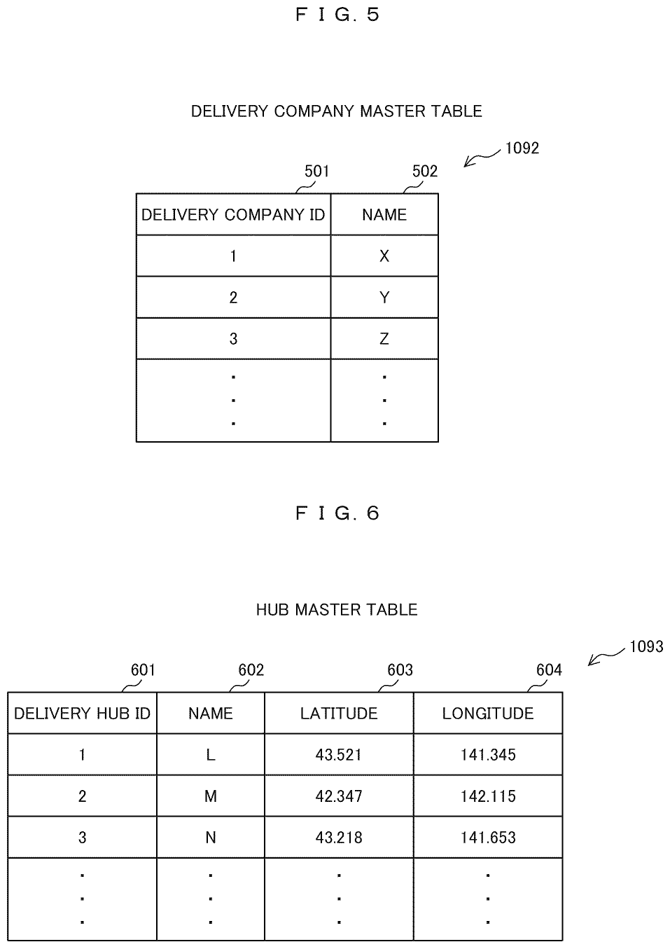

In addition, for “4. Compatibility between Delivery Company and Cargo Owner”, the multi-objective optimization unit 102 is capable of performing calculation in a procedure storing a file in which a compatibility value such as (1) between the delivery company and the cargo owner is defined in advance, (2) setting information indicating the “delivery company” for each delivery route of each vehicle (for example, a delivery company ID illustrated in FIG. 5), (3) setting information indicating the “cargo owner” for each cargo (for example, a cargo owner illustrated in FIG. 4), (4) acquiring the compatibility value between the delivery company and the cargo owner for each delivery from the file defined in (1), for each state where the delivery route compatibility average value of each vehicle=the delivery route of each vehicle, to obtain the average value, and (5) obtaining the lowest value of the delivery route compatibility value of each vehicle from a state where the compatibility between the delivery company and the cargo owner=all the delivery routes (Equation 4).

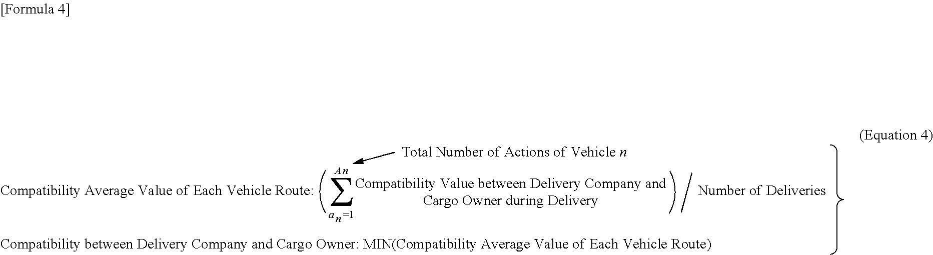

In addition, for “5. Number of Operation Plan Change Sites”, the multi-objective optimization unit 102 is capable of performing calculation in a procedure such as (1) acquiring the number of operation plan changes of each vehicle on the delivery route, and (2) adding a state where the number of operation plan change sites=the number of operation plan changes of all the vehicles on the delivery route (Equation 5). For (1), in a case where there are a set of additional orders (including the delivery) on the existing route, the multi-objective optimization unit 102 counts 1.

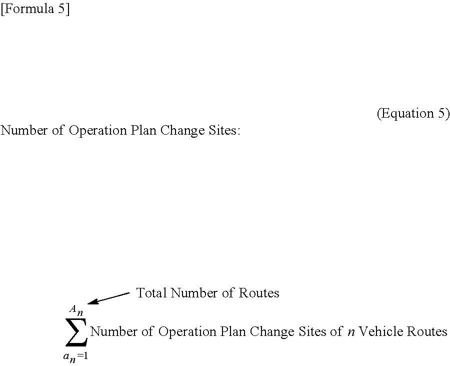

The index value normalization unit 103 outputs a normalization index value obtained by normalizing the value of each index of each solution included in the solution set of the solution set index data 1097 calculated by the multi-objective optimization unit 102, and a normalization index value vector of which the component is the normalization index value. In addition, the index value normalization unit 103 accumulates the normalization index value vector as the learning data 1098. The reason for normalization is that there are different standards for a superior or inferior relationship such as the unit of each index or the size of the value (for example, a relationship in which a larger value is closer to the best value or a smaller value is closer to the best value).

For example, the total movement distance and the distribution of the revenue are a standard in which it is preferable when the value becomes smaller. The total movement distance is the total movement distance of the vehicle delivering the cargo, and the distribution of the revenue is an index indicating that how evenly cargos are transported on the delivery route (it is preferable when there is no vacant vehicle). In addition, the average of the vehicle occupation rate and the compatibility between the delivery company and the cargo owner are a standard in which it is preferable when the value becomes larger. The average of the vehicle occupation rate is a ratio of the vehicle delivering the cargo rather than the vacant vehicle, and the compatibility between the delivery company and the cargo owner is a ratio of the cargo owner requesting a specific delivery company for all the delivery companies. In addition, the number of operation plan change sites is a standard in which it is preferable when the value becomes smaller. The number of operation plan change sites is the number of sites at which the vehicle changes the operation plan for the delivery route in accordance with the additional order. For example, in a case where the departure hub becomes another departure hub and the delivery route is changed, the number of sites at which the operation plan is changed is 1. The index value normalization unit 103, on the basis of such standards, normalizes “1” as the best value and “0” as the worst value such that the index weight does not become 0 vector.

The index weight prediction unit 104 inputs the normalization index value vector of which the component is the normalization index value, output by the index value normalization unit 103, to the learned learning model learned by the index weight learning unit 108, and outputs a prediction index weight vector of which the component is each index of the Pareto solution included in the solution set index data 1097 to each Pareto solution.

The solution recommendation unit 105, on the basis of the degree of cosine similarity between the normalization index value vector output by the index value normalization unit 103 and the prediction index weight vector output by the index weight prediction unit 104, sorts and outputs the recommended solution that is the Pareto solution to be recommended, with a predetermined standard.

The solution selection unit 106 outputs information such as a delivery route for selecting the user preference solution from the recommended solutions output by the solution recommendation unit 105, the index value distribution of the recommended solution, and the route of the delivery recommended solution to the output device 1605. In addition, the solution selection unit 106 receives the selection of the user preference solution from the user via the input device 1606.

The index weight calculation unit 107 outputs the user preference solution that is the Pareto solution selected by the user from Pareto the solutions presented as the recommended solution, as the training data. The index weight calculation unit 107 specifies the normalization index value corresponding to the value of each index of the Pareto solution configuring the output training data, from the normalization index value output by the index value normalization unit 103, and outputs a normalization index value vector of which the component is the specified normalization index value. The index weight calculation unit 107 feeds back and adds the normalization index value vector to the past learning data 1098 accumulated by the index value normalization unit 103.

The index weight learning unit 108 learns the learning data 1098 that is accumulated by the index value normalization unit 103 and added by the index weight calculation unit 107 by a neural network, a decision tree, or the like to update the learning model. Specifically, the index weight learning unit 108 fits the prediction index weight vector output by the index weight prediction unit 104 such that a difference from a normalization index value vector of which the component is each index of the Pareto solution output as the training data is minimized.

FIG. 3C is a diagram for illustrating the prediction index weight vector output by the index weight prediction unit 104 using the learning model index weight learning unit 108. As illustrated in FIG. 3C, the index weight learning unit 108 inputs the learning data 1098 accumulated as the normalization index value vector of which the component is the normalization index value obtained from the past solution set index data 1097 to the learning model such as a neural network or a decision tree. In this example, the index weight learning unit 108 extracts the number N of indices (in this example, N=5) for target days (for example, in the recent month) and a solution set index value (CSV) of the number M of solutions (in this example, M=100) from the learning data 1098.

In order to increase a learning efficiency, the index weight learning unit 108 outputs a normalization index value vector scaled such that the sum of each component of the neuron is 1 using Equation 6 described below, as the prediction index weight vector.

$$\begin{matrix}[ Formula 6 ] & \\ h {1}_{j} = a ( {\sum }_{i} {w}_{i j} {x}_{i} + {b}_{j} ) & ( Equation 6 )\end{matrix}$$

Specifically, for the input learning data 1098, the index weight learning unit 108 determines a value in which a prediction error (the degree of cosine similarity with a reverse sign) from a normalization index value vector of which the component is the normalization index value corresponding to the value of each index of the Pareto solution configuring the training data is minimized while gradually changing coefficients w and b in Equation 1 to update the learning model so far. The index weight prediction unit 104 described above inputs the normalization index value vector output by the index value normalization unit 103 to the learning model updated by the index weight learning unit 108, and outputs the prediction index weight vector described above to each Pareto solution.

Subsequently, various data pieces stored by the storage unit 109 will be described.

FIG. 4 is a diagram illustrating an example of the cargo owner master table 1091. The cargo owner master table 1091 is a table for managing the cargo owner using this system. As illustrated in FIG. 4, in the cargo owner master table 1091, a cargo owner ID 401 for identifying the cargo owner and a name 402 of the cargo owner are stored in association with each other. In FIG. 4, for example, it is found that a cargo owner identified by a cargo owner ID “1” has a name “A”.

FIG. 5 is a diagram illustrating an example of the delivery company master table 1092. The delivery company master table 1092 is a table for managing the delivery company using this system. As illustrated in FIG. 5, in the delivery company master table 1092, a delivery company ID 501 for identifying the delivery company and a name 502 of the delivery company are stored in association with each other. In FIG. 5, for example, it is found that a delivery company identified by a delivery company ID “1” has a name “X”.

FIG. 6 is a diagram illustrating an example of the hub master table 1093. The hub master table 1093 is a table that is stored for each delivery company and for managing the delivery hub on the delivery route circulated by the delivery company. As illustrated in FIG. 6, in the hub master table 1093, a delivery hub ID 601 for identifying the delivery hub, a name 602 of the delivery hub, and a latitude 603 and a longitude 604 of the delivery hub are stored in association with each other. In FIG. 6, for example, it is found that a delivery hub identified by a delivery hub ID “1” has a name “L”, and is positioned at a latitude “43.521” and a longitude “141.345”.

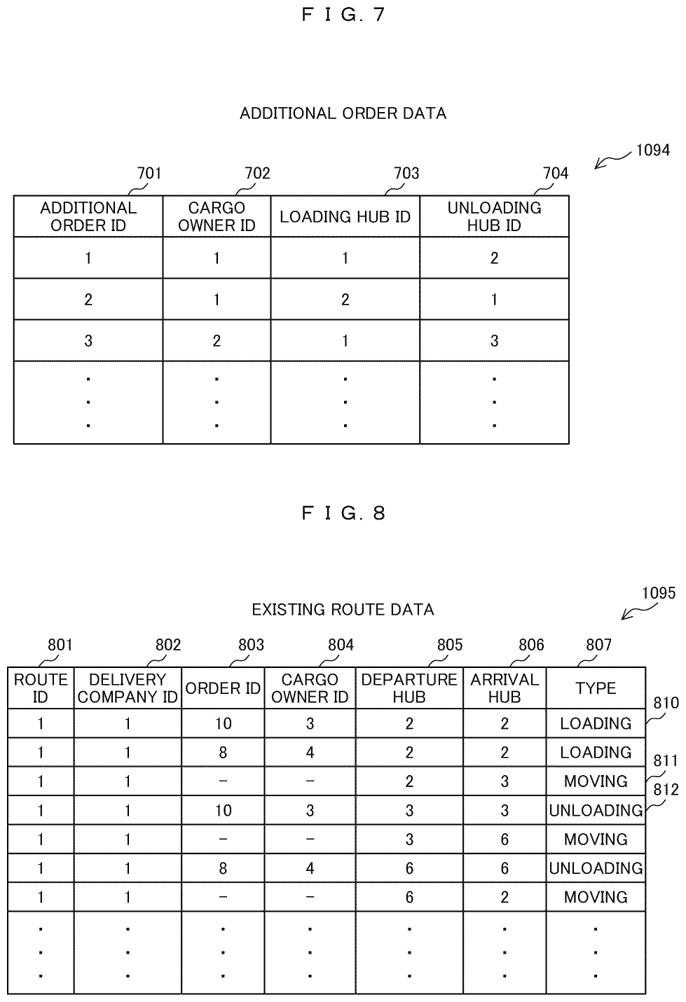

FIG. 7 is a diagram illustrating an example of the additional order data 1094. The additional order data 1094 is a table that is stored for each delivery company and is for managing the additional delivery order on the delivery route circulated by the delivery company. As illustrated in FIG. 7, in the additional order data 1094, an additional order ID 701 for identifying the additional delivery order, a cargo owner ID 702 for which the additional delivery order is performed, and a latitude 703 and a longitude 704 of a delivery hub for which the additional delivery order is performed are stored in association with each other. In FIG. 7, for example, an additional delivery order identified by an additional order ID “1” indicates an order for delivering a cargo from a hub identified by a loading hub ID “1” to a hub identified by an unloading hub ID “2” of the cargo owner identified by the cargo owner ID “1”.

FIG. 8 is a diagram illustrating an example of the existing route data 1095. The existing route data 1095 is a table for managing the existing delivery route for the delivery company to deliver the cargo. As illustrated in FIG. 8, in the existing route data 1095, a route ID 801 for identifying the existing delivery route, a delivery company ID 802, an order ID 803 for identifying the delivery order, a cargo owner ID 804, a departure hub 805 that is a hub from which the cargo departs, an arrival hub 806 that is a hub at which the cargo arrives, and a type 807 indicating the state of the delivery are stored in association with each other. In FIG. 8, for example, a delivery route identified by a route ID “1” is received by the delivery company identified by the delivery company ID “1”, as a delivery order identified by a delivery order ID “10”, and indicates a delivery route on which the cargo of a cargo owner identified by a cargo owner ID “3” is loaded at a hub identified by a departure hub ID “2” (a record 810), is moved from the hub of the hub ID “2” to a hub of a hub ID “3” (a record 811), and unloaded at the hub identified by the unloading hub ID “3”.

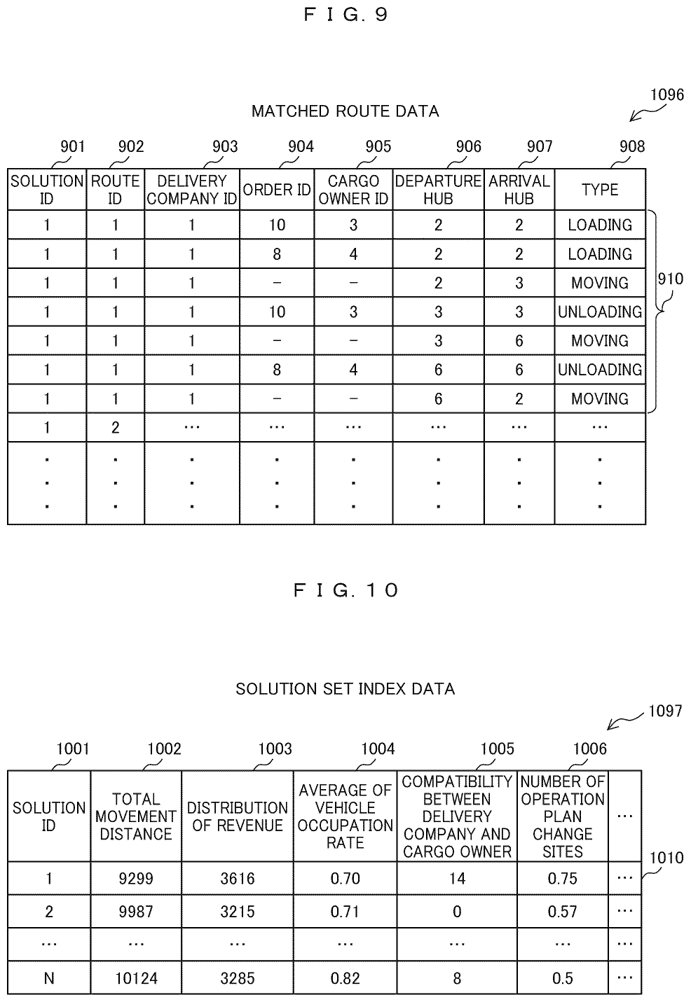

FIG. 9 is a diagram illustrating an example of the matched route data 1096. As illustrated in FIG. 3A, the matched route data 1096 is a table for managing a matched route in which the additional order is incorporated in the existing delivery route.

As illustrated in FIG. 9, in the matched route data 1096, as with the existing route data 1095 illustrated in FIG. 8, a route ID 902, a delivery company ID 903, an order ID 904, a cargo owner ID 905, a departure hub 906, an arrival hub 907, and a type 908, and further, a solution ID 901 for identifying the Pareto solution are stored in association with each other. In FIG. 9, for example, a record group 910 identified by the route ID “1” is one route among delivery routes attained by a Pareto solution identified by a solution ID “1”, and as with the record group 910, the same storage applies to record groups identified by a route ID “2” and the subsequence. That is, in the matched route data 1096, specific contents of the delivery route satisfying each Pareto solution are stored. The association between the solution ID and other items in the matched route data 1096 can be performed by the multi-objective optimization unit 102 using each data piece of Equations 1 to 5 and FIGS. 4 to 8 used when the multi-objective optimization unit 102 derives the Pareto solution for each index.

FIG. 10 is a diagram illustrating an example of the solution set index data 1097. The solution set index data 1097 is set data of the Pareto solution between the indices output by the multi-objective optimization unit 102. As illustrated in FIG. 10, in the solution set index data 1097, each index when the Pareto solution is derived is stored. In this example, each value of five indices (1. Total Movement Distance, 2. Distribution of Revenue, 3. Average of Vehicle Occupation Rate, 4. Compatibility between Delivery Company and Cargo Owner, and 5. Number of Operation Plan Change Sites) described above is stored. Such a value is calculated by using Equations 1 to 5 and FIGS. 4 to 8 described above.

For example, it is found that in each index of the Pareto solution identified by the solution ID “1” (a record 1010), the total movement distance is “9299”, the distribution of the revenue is “3616”, the average of the vehicle occupation rate is “0.70”, the compatibility between the delivery company and the cargo owner is “14”, and the number of operation plan change sites is “0.75”. The number N of Pareto solutions is the number of solutions output by the multi-objective optimization in one matching.

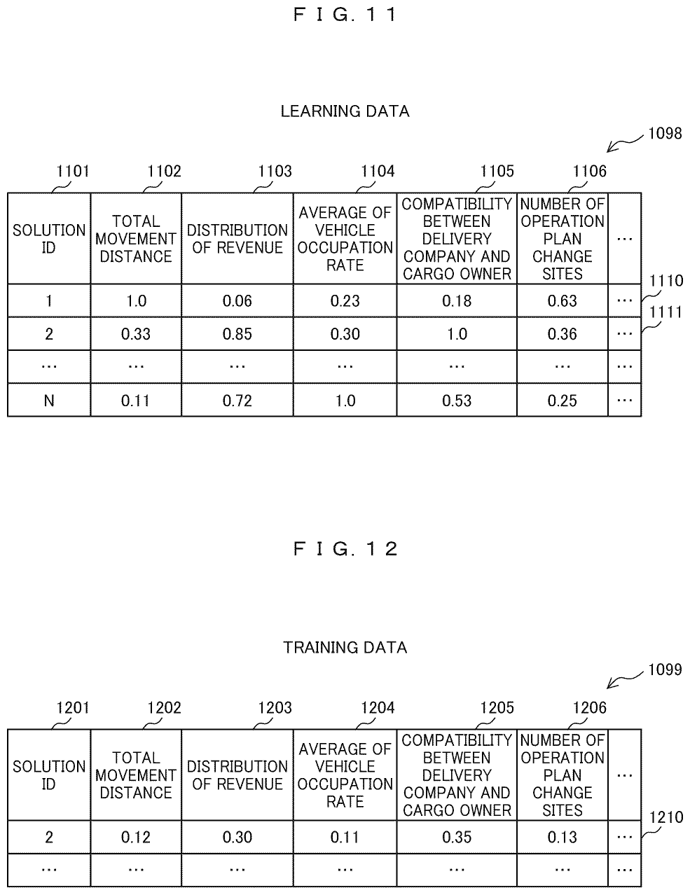

FIG. 11 is a diagram illustrating an example of the learning data 1098. The learning data 1098 is set data of the Pareto solution obtained by normalizing each index of the solution set index data 1097, output by the index value normalization unit 103. As illustrated in FIG. 11, in the learning data 1098, a normalization index value obtained by normalizing the same index as that of the solution set index data 1097 is stored. For example, it is found that in each index of the normalized Pareto solution identified by the solution ID “1” (a record 1110), the total movement distance is “1.0”, the distribution of the revenue is “0.06”, the average of the vehicle occupation rate is “0.23”, the compatibility between the delivery company and the cargo owner is “0.18”, and the number of operation plan change sites is “0.63”.

FIG. 12 is a diagram illustrating an example of the training data 1099. The training data 1099 is the normalization index value vector of which the component is the normalization index value corresponding to the value of each index of the user preference solution selected by the user from the Pareto solutions presented as the recommended solution. The training data 1099 is scaled such that the sum of the components that are the value of each index of the user preference solution is 1. For example, in a case where the user selects a Pareto solution identified by a solution ID “2”, and the solution selection unit 106 outputs the selected Pareto solution as the user preference solution, the index weight calculation unit 107 reads out each index of the normalized Pareto solution identified by the solution ID “2” (a record 1210), and performs scaling such that the sum of each component is 1. In this example, it is described that each index of the Pareto solution identified by the solution ID “2” is scaled, and a record 1210 is accumulated in which the total movement distance is “0.12”, the distribution of the revenue is “0.30”, the average of the vehicle occupation rate is “0.11”, the compatibility between the delivery company and the cargo owner is “0.35”, and the number of operation plan change sites is “0.13”.

Subsequently, processing performed in this system will be described.

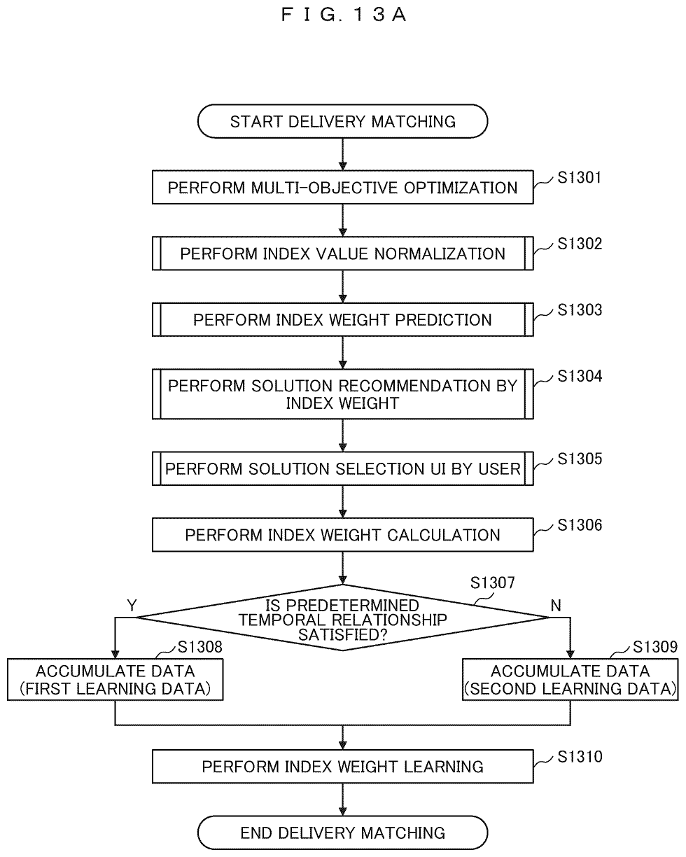

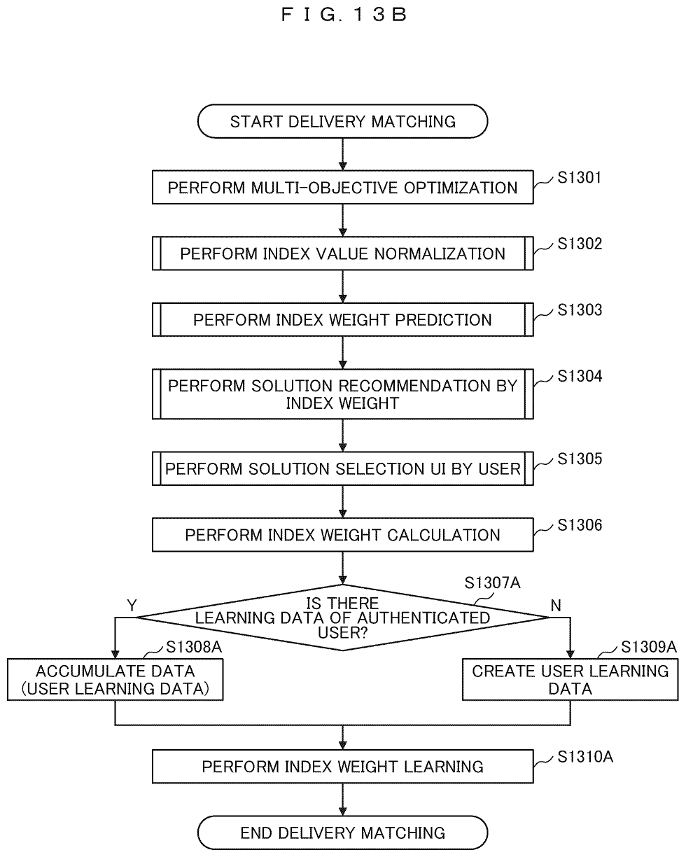

FIG. 13A is a flowchart illustrating an example of a processing procedure of delivery matching processing performed in this system. As illustrated in FIG. 13A, the multi-objective optimization unit 102 performs multi-objective optimization processing of deriving a Pareto solution between predetermined indices, for the combination in which the additional delivery order is allocated to the delivery route, and the combination of the circulation orders for each combination, of which the input is received by the input and output unit 101, and outputting the Pareto solution as the solution set index data 1097 (step 1301). The predetermined index, for example, is five indices of the total movement distance, the distribution of the revenue, the average of the vehicle occupation rate, the compatibility between the delivery company and the cargo owner, and the number of operation plan change sites, described above. In the multi-objective optimization of step 1301, the multi-objective optimization unit 102 outputs the matched route data 1096 that is the delivery route (a solution route) corresponding to each of the derived Pareto solutions, together with the solution set index data 1097.

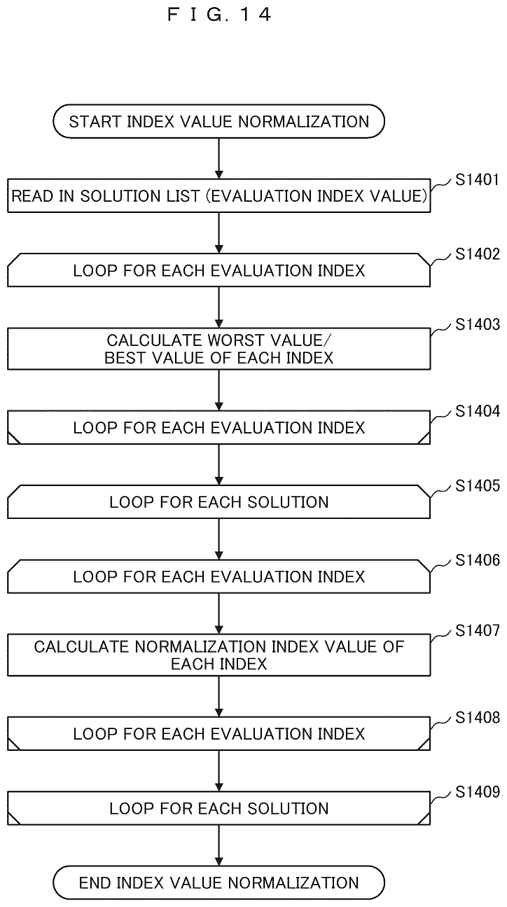

The index value normalization unit 103 performs index value normalization processing of normalizing the value of each index of each Pareto solution included in the solution set of the solution set index data 1097 calculated by the multi-objective optimization unit 102, and outputting the normalization index value as the learning data 1098 (step 1302). The index value normalization processing will be described below using FIG. 14.

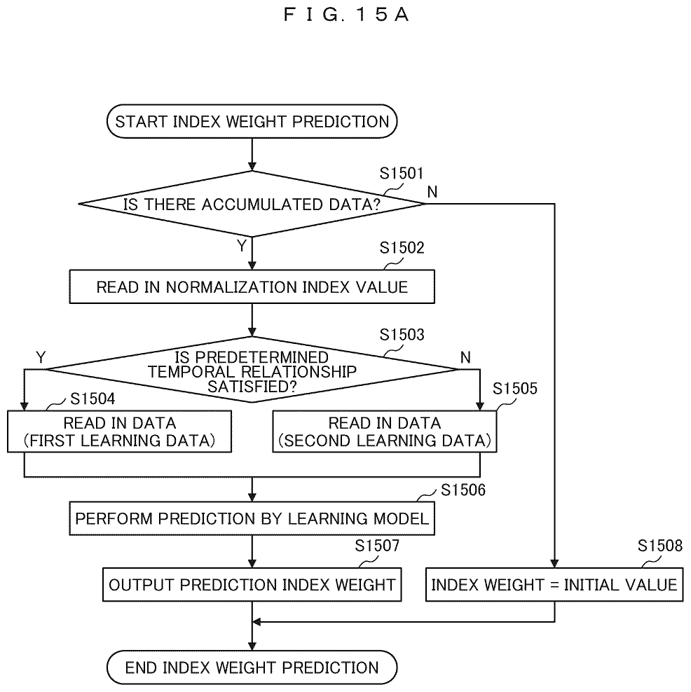

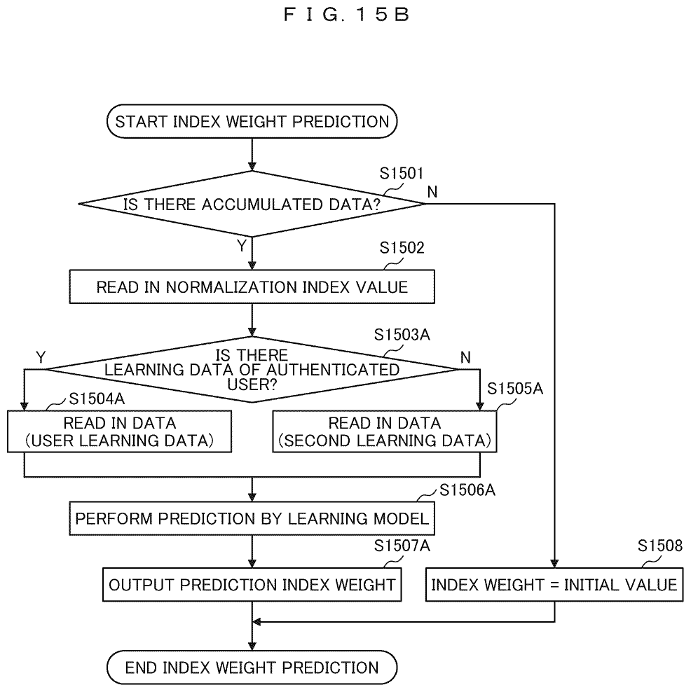

The index weight prediction unit 104 performs index weight prediction processing of inputting the normalization index value output by the index value normalization unit 103 to the learned learning model, and outputting a prediction index weight vector of which the component is the each index of the user preference solution selected by the user (step 1303). The index weight prediction processing will be described below using FIGS. 15A and 15B.

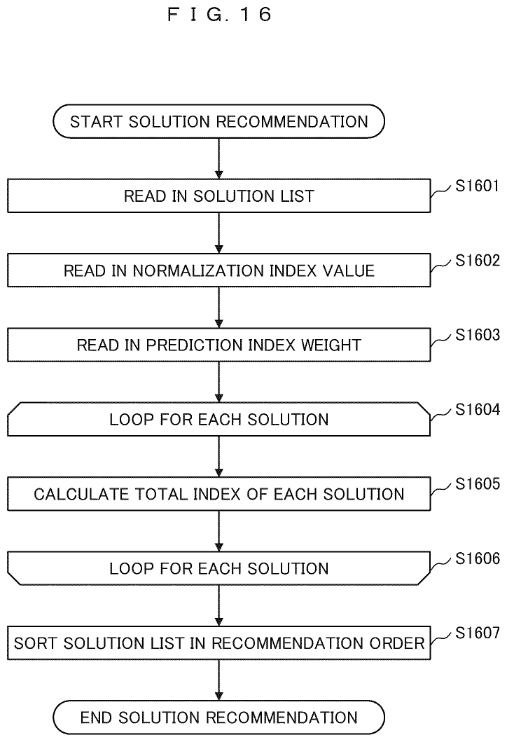

The solution recommendation unit 105 performs solution recommendation processing of outputting the recommended solution that is the recommended Pareto solution, on the basis of the degree of cosine similarity between a normalization index value vector of which the component is the normalization index value of the Pareto solution included in the learning data 1098 output in step 1302 and the index weight prediction vector output in step 1303 (step 1304). The solution recommendation processing will be described below using FIG. 16.

The solution selection unit 106 performs solution selection processing of allowing the user to select the recommended solution output in step 1304 (step 1305). The solution selection processing will be described below using FIG. 19.

The index weight calculation unit 107 calculates the normalization index value vector in which the sum of each component is 1 from the normalization index value of the user preference solution that is the Pareto solution selected in step 1305, and outputs the normalization index value vector as the training data 1099 (step 1306).

The index weight calculation unit 107 determines whether the current time and a delivery time satisfy a predetermined temporal relationship (step 1307). In a case where the predetermined temporal relationship is satisfied, for example, in a case where a timing for performing this processing is a timing a certain amount of time or longer before the delivery time such that the current time is the day or the previous day of the delivery time, the index weight calculation unit 107 determines that the predetermined temporal relationship is satisfied. That is, the index weight calculation unit 107 executes either of the following steps 1308 and 1309 in accordance with the time until the delivery.

In step 1307, in a case where it is determined that the current time and the delivery time satisfy the predetermined temporal relationship (step 1307; Yes), the index weight calculation unit 107 accumulates the prediction index weight vector calculated in step 1306 in first learning data (step 1308). For example, in a case where the current time is one day or more before the delivery time (that is, before the previous day), the index weight calculation unit 107 determines that the predetermined temporal relationship is satisfied, and accumulates the prediction index weight vector calculated in step 1306 in the learning data 1098 (the first learning data).

On the other hand, in step 1307, in a case where the current time and the delivery time do not satisfy the predetermined temporal relationship (step 1307; No), the index weight calculation unit 107 accumulates the prediction index weight vector calculated in step 1306 in second learning data (step 1309). For example, in a case where the current time is not one day or more before the delivery time (that is, the day), the index weight calculation unit 107 determines that the predetermined temporal relationship is not satisfied, and accumulates the prediction index weight vector calculated in step 1306 in the learning data 1098 (the second learning data).

In this example, the index weight calculation unit 107 performs step 1307, and dividedly accumulates the learning data on the basis of the relationship between the current time and the delivery time, but it is not necessary to perform step 1307, and the prediction index weight vector calculated in step 1306 may be accumulated as one of the learning data 1098, regardless of the relationship between the current time and the delivery time. By performing step 1307, the value of each component of the normalization index value vector of which the component is the normalization index value of the Pareto solution included in the learning data 1098 output in step 1302, and the value of each component of the prediction index weight vector scaled in step 1306 are added to the past data, and learning data according to a predetermined relationship (for example, the learning data for the recent target days and the learning data for the day) is accumulated.

The index weight learning unit 108 inputs the learning data 1098 accumulated in step 1308 and step 1309 to the learning model such as a neural network and a decision tree illustrated in FIG. 3C, and determines a value in which the prediction error from the training data 1099 is minimized to update the learning model so far (step 1310).

In this example, the learning data 1098 is accumulated in accordance with the temporal relationship, but the learning data 1098 may be accumulated in accordance with the user using this system. In this case, for example, a user is registered as a customer of this system before the delivery matching processing is executed, and then, login processing of authenticating a user input when using this system with the registered user is performed. By performing such login processing, it is possible to execute the delivery matching processing by switching the user.

The multi-objective optimization unit 102 accumulates the solution set index data 1097 and the matched route data 1096 output by the execution of step 1301, and the authenticated user authenticated by the login processing in association with each other. Then, for the authenticated user, in a case where each processing of steps 1301 to 1306 illustrated in FIG. 13A is performed in this system, as illustrated in FIG. 13B, the index weight calculation unit 107 determines whether there is the learning data 1098 of the authenticated user (step 1307A).

In a case where it is determined that there is the learning data 1098 of the authenticated user (step 1307A; Yes), the index weight calculation unit 107 accumulates user learning data that is the learning data 1098 for the authenticated user (step 1308A). On the other hand, in a case where it is determined that there is no learning data 1098 of the authenticated user (step 1307A; No), the index weight calculation unit 107 newly creates the user learning data for the authenticated user (step 1309A). Then, the index weight learning unit 108 inputs the learning data 1098 accumulated for each authenticated user in step 1308 and step 1309 to the learning model described above, and determines a value in which the prediction error from the training data 1099 for each authenticated user is minimized to update the learning model so far of each authenticated user (step 1310A).

As described above, by accumulating the learning data 1098 for each authenticated user to update the learning model, it is possible to switch the learning model in accordance with the user using this system. As a result thereof, it is possible to present the recommended solution that is further matched with the preference of the user. Definitely, in accordance with the environment where this system is used, the processing illustrated in FIG. 13A and the processing illustrated in FIG. 13B may be executed in combination. Accordingly, after considering the temporal relationship, it is possible to further update the learning model of each authenticated user, and present the recommended solution that is matched with the preference of the user.

FIG. 14 is a flowchart illustrating an example of a processing procedure of the index value normalization processing.

As illustrated in FIG. 14, the index value normalization unit 103 reads in the value (an evaluation index value) of each index of each Pareto solution included in the solution set (a solution list) of the solution set index data 1097 calculated by the multi-objective optimization unit 102 (step 1401).

The index value normalization unit 103 performs the following processing for each index read in step 1401 (steps 1402 and 1404).

The index value normalization unit 103 calculates the worst value (Ai: the worst value of an index i) and the best value (Bi: the best value of the index i) of the read index (step 1403). For example, the index value normalization unit 103, for each index of the total movement distance, the distribution of the revenue, and the number of operation plan change sites, sets the maximum value of the indices as the worst value, and for each index of the average of the vehicle occupation rate and the compatibility with the delivery company, sets the minimum value of the indices as the worst value.

In addition, for example, the index value normalization unit 103, for each index of the total movement distance, the distribution of the revenue, and the number of operation plan change sites, sets the minimum value of the indices as the best value, and for each index of the average of the vehicle occupation rate and the compatibility with the delivery company, sets the maximum value of the indices as the best value.

Subsequently, the index value normalization unit 103 performs the following processing for each Pareto solution included in the solution list (steps 1405 and 1409).

Further, the index value normalization unit 103 performs the following processing for each index of the Pareto solution (steps 1406 and 1408).

The index value normalization unit 103 calculates the normalization index value of each index (step 1407). For example, the index value normalization unit 103 calculates a normalization index value fi of the index i by fi=(f′i−Ai)/(Bi−Ai). Here, f′i represents the i-th index value. In a case where step 1409 is ended, the index value normalization processing illustrated in FIG. 14 is ended. In a case where the processing is ended, the index value normalization unit 103 outputs the normalization index value in which each index value of the Pareto solution included in the solution set index data 1097 is normalized, and outputs the normalization index value vector of which the component is the normalization index value as the learning data 1098.

FIG. 15A is a flowchart illustrating an example of a processing procedure of the index weight prediction processing. As illustrated in FIG. 15A, the index weight prediction unit 104 determines whether there is the learning data 1098 accumulated in the past (step 1501). In a case where it is determined that there is no learning data 1098 accumulated in the past (step 1501; No), the index weight prediction unit 104 determines that learning is not performed since there is no past learning data 1098, and reads out and outputs the initial learning data in which the initial value set in advance is stored (step 1508).

On the other hand, in a case where it is determined that there is the learning data 1098 accumulated in the past (step 1501; Yes), the index weight prediction unit 104 reads in the normalization index value of the Pareto solution included in the solution set index data 1097 output by the multi-objective optimization unit 102, of which the input is received by the input and output unit 101 (step 1502).

The index weight prediction unit 104 determines whether the current time and the delivery time satisfy the predetermined temporal relationship (step 1503). The predetermined temporal relationship is the same as in step 1307.

In step 1503, in a case where it is determined that the current time and the delivery time satisfy the predetermined temporal relationship (step 1503; Yes), the index weight prediction unit 104 reads in the first learning data accumulated in step 1308 (step 1504).

On the other hand, in step 1503, in a case where it is determined that the current time and the delivery time do not satisfy the predetermined temporal relationship (step 1503; No), the index weight prediction unit 104 reads in the second learning data accumulated in step 1309 (step 1505).

The index weight prediction unit 104 inputs the normalization index value vector of which the component is the normalization index value read in step 1502 to the learned learning model learned by the index weight learning unit 108 reading in the learning data in step 1504 or step 1505 (step 1506), and outputs the prediction index weight vector of which the component is each index of the Pareto solution included in the solution set index data 1097 for each Pareto solution (step 1507). In a case where the processing is ended, the prediction index weight vector obtained by learning the normalization index value vector of the Pareto solution included in the solution set index data 1097 with the newest learning model is output for each Pareto solution.

In this example, the learning data 1098 is read in accordance with the temporal relationship, but as with FIGS. 13A and 13B, the learning data 1098 may be read in accordance with the user using this system. In this case, in a case where each processing of steps 1501 to 1502 illustrated in FIG. 15A is performed, as illustrated in FIG. 15B, the index weight prediction unit 104 determines whether there is the learning data 1098 of the authenticated user (step 1503A). Then, in step 1503A, in a case where it is determined that there is the learning data 1098 of the authenticated user (step 1503A; Yes), the index weight prediction unit 104 reads in the user learning data accumulated in step 1308A (step 1504A).

On the other hand, in step 1503A, in a case where there is no learning data 1098 of the authenticated user (step 1503A; No), the index weight prediction unit 104 reads in the user learning data created in step 1309A (step 1505A).

Then, the index weight prediction unit 104 inputs the normalization index value vector read in step 1502 to the learned learning model for each authenticated user learned by the index weight learning unit 108 reading in the user learning data in step 1504A or step 1505A (step 1506A), and for each authenticated user, outputs the prediction index weight vector of which the component is each index of the Pareto solution included in the solution set index data 1097 for each Pareto solution (step 1507A).

As described above, the learning data 1098 is accumulated for each authenticated user, the updated learning model is read in, and the prediction index weight vector is output, and thus, the prediction index weight vector can be output in accordance with the user using this system. As a result thereof, it is possible to present the recommended solution that is further matched with the preference of the user. Definitely, in accordance with the environment where this system is used, the processing illustrated in FIG. 15A and the processing illustrated in FIG. 15B may be executed in combination. Accordingly, in consideration of the temporal relationship, it is possible to further output the prediction index weight vector according to each authenticated user, and present the recommended solution that is matched with the preference of the user.

FIG. 16 is a flowchart illustrating an example of a processing procedure of the solution recommendation processing.

As illustrated in FIG. 16, as with step 1401, the solution recommendation unit 105 reads in the value of each index of each Pareto solution included in the solution set (the solution list) of the solution set index data 1097 calculated by the multi-objective optimization unit 102 (step 1601).

The solution recommendation unit 105 reads in the normalization index value for each index of each Pareto solution read in step 1601 (step 1602). The normalization index value to be read in is a value calculated in the index value normalization processing in FIG. 14.

The solution recommendation unit 105 reads in each component of the prediction index weight vector of each Pareto solution (step 1603). The prediction index weight vector to be read in is a vector calculated in the index weight prediction processing in FIGS. 15A and 15B.

The solution recommendation unit 105 performs the following processing for each Pareto solution read in step 1601 (steps 1604 and 1606).

The solution recommendation unit 105 calculates the degree of cosine similarity between the normalization index value vector of the normalization index value read in step 1602 and the index weight vector output in step 1603, and sets the calculated degree of cosine similarity as the total index for each Pareto solution (step 1605).

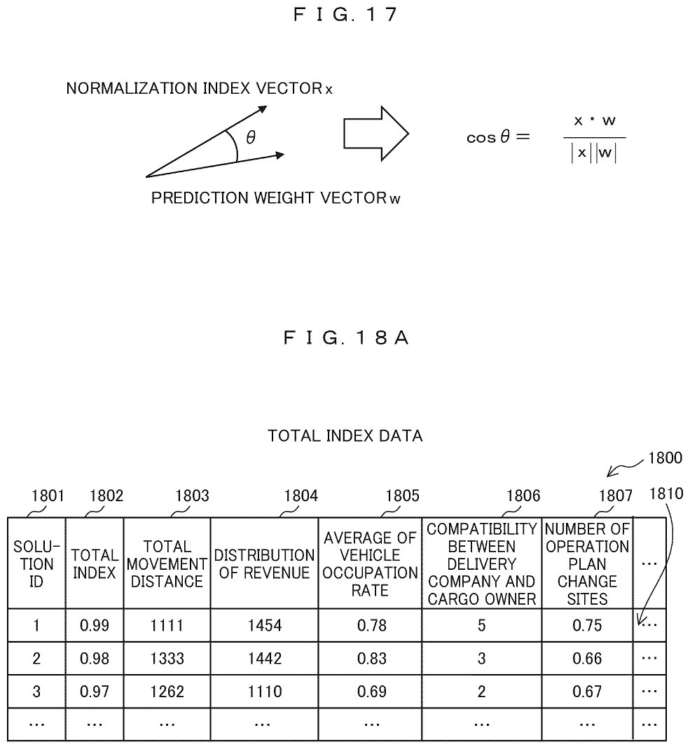

FIG. 17 is a diagram for illustrating a method for calculating the degree of cosine similarity. In FIG. 17, the degree (cos θ) of cosine similarity between a normalization index value vector x and a prediction index weight vector w is calculated by the right equation in FIG. 17. As the calculated degree of cosine similarity increases, the normalization index value vector x becomes closer to the prediction index weight vector w, which indicates the Pareto solution that is likely to be selected by the user, that is, the Pareto solution that is likely to be the user preference solution.

The solution recommendation unit 105 sorts each Pareto solution read in step 1601 such that the larger the value of the total index calculated in step 1605 is, the higher the position is in order, and then, outputs the total index data in which each Pareto solution is associated with the total index (step 1606). That is, in step 1606, the solution recommendation unit 105 outputs a recommended solution list in which the Pareto solution is sorted in a recommendation order as the total index data.

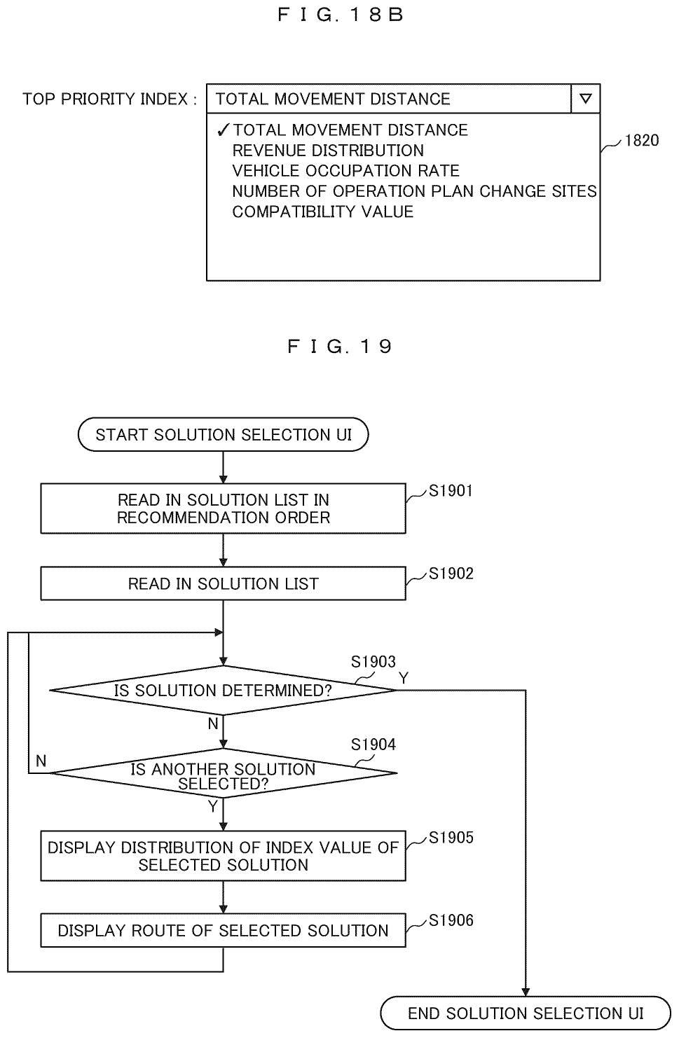

FIG. 18A is a diagram illustrating an example of the total index data. As illustrated in FIG. 18A, in total index data 1800, the total index described above is stored in association with each Pareto solution of the solution set index data 1097 illustrated in FIG. 10. In FIG. 18A, the solution recommendation unit 105 outputs a record 1810 of a total index “0.99” as the most recommended Pareto solution.

In FIG. 18A, the solution recommendation unit 105 outputs the Pareto solution sorted in descending order of the total index as the total index data 1800, but the output position of the index value of the Pareto solution may be changed in accordance with the superior or inferior relationship of each index value of the Pareto solution. For example, in a case where there are five indices of the total movement distance, the distribution of the revenue, the average of the vehicle occupation rate, the compatibility between the delivery company and the cargo owner, and the number of operation plan change sites, the solution recommendation unit 105 calculates how close each index is to the best value. The solution recommendation unit 105 replaces and displays the index closer to the best value of each index to a position that is easier for the user to visually recognize. The solution recommendation unit 105, as the position that is easier for the user to visually recognize, for example, displays an index closest to the best value at a position on the right of the total index 1802 illustrated in FIG. 18A, and displays an index next closest to the best value at a position on the further right. As described above, the index closer to the best value is displayed at the position close to the solution ID 1801 or the total index 1802. Accordingly, it is possible to easily grasp which index contributes to the order sorted as the recommended solution.

Further, the user desired index may be displayed at the position that is easier for the user to visually recognize. For example, as illustrated in FIG. 18B, on a screen where the user selects the index, the user selects an index with the highest degree of priority from a pull-down menu, and the solution recommendation unit 105, as illustrated in FIG. 18A, displays the selected index at a position closest to the solution ID 1801 or the total index 1802. Thereafter, in a case where an index with the next highest degree of priority is selected, the index is displayed at a position on the right of the index displayed at the position closest to the solution ID or the total index. In FIG. 18B, as a default, the “total movement distance” is displayed as a top priority index, but the user can select a desired index from a pull-down menu 1820. Then, the solution recommendation unit 105 outputs the Pareto solution in which the index value of the index (in this example, the “total movement distance”) selected as the top priority index is sorted in descending order, as the total index data 1800.

As described above, the solution recommendation unit 105 displays the selected index with a higher degree of priority at the position close to the solution ID 1801 or the total index 1802, and sorts the index value in descending order. Accordingly, an index that is carefully checked by the user can be displayed at an easily visible position, and the index selected by the user can be sorted in descending order, and thus, it is possible to provide an environment in which the Pareto solution is more easily selected by the user.

In a case where the processing illustrated in FIG. 16 is ended, the solution list in the recommendation order in which the Pareto solution with respect to the solution set index data 1097 is sorted in the recommendation order is output.

FIG. 19 is a flowchart illustrating an example of a processing procedure of the solution selection processing.

As illustrated in FIG. 19, the solution selection unit 106 reads in the solution list in the recommendation order output in FIG. 16 (step 1901). Further, the solution selection unit 106 reads in the matched route data 1096 that is the delivery route (the solution route) corresponding to each Pareto solution of the solution list, output in step 1301 of FIGS. 13A and 13B (step 1902).

The solution selection unit 106 determines whether a desired Pareto solution is selected as the user preference solution by the user from the solution list in the recommendation order output in FIG. 16 via the input device 1606 (step 1903), and in a case where it is determined that the desired Pareto solution is selected as the user preference solution by the user (step 1903; Yes), the processing is ended.

On the other hand, in a case where it is determined that the desired Pareto solution is not selected as the user preference solution by the user (step 1903; No), the solution selection unit 106 determines whether another Pareto solution is selected as the user preference solution (step 1904). In a case where the solution selection unit 106 determines that another Pareto solution is not selected as the user preference solution (step 1904; No), the processing returns to step 1903, and the processing is repeated until the user preference solution is selected.

On the other hand, in a case where it is determined that another Pareto solution is selected as the user preference solution (step 1904; Yes), the solution selection unit 106 displays the distribution of each index value of the selected user preference solution or the delivery route on the output device 1605 (steps 1905 and 1906).

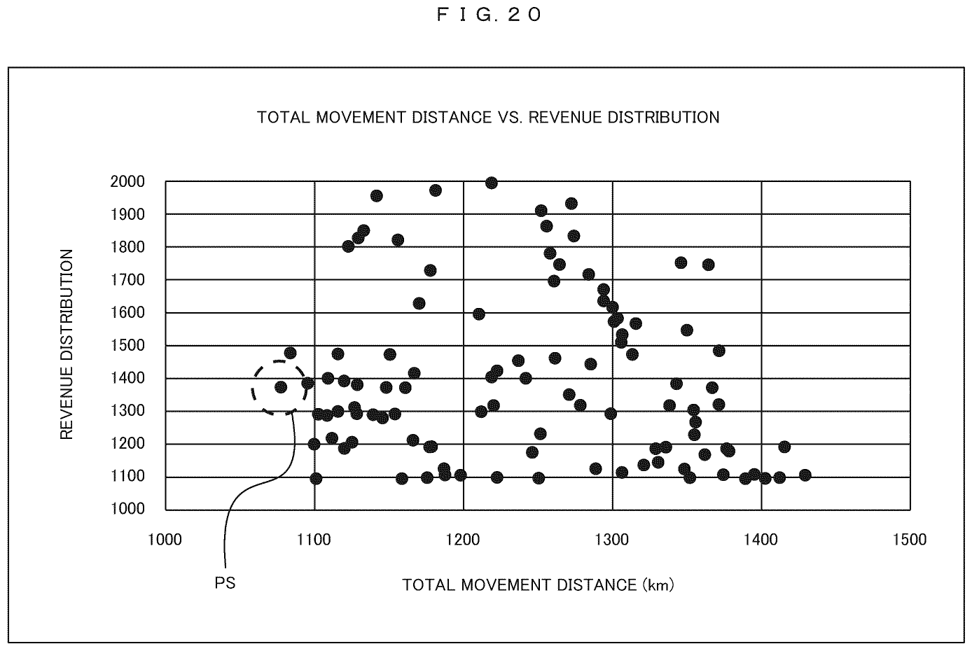

FIG. 20 is a diagram illustrating an example of the distribution of each index value of the selected Pareto solution (user preference solution), output in step 1905. As illustrated in FIG. 20, the solution selection unit 106, as with the drawing for illustrating an example of the Pareto solution illustrated in FIG. 3B, displays the distribution of each index value of the Pareto solutions for the plurality of indices on the output device 1605. In FIG. 20, as with FIG. 3B, the distribution of each index value between the total movement distance (a horizontal axis) and the distribution of the revenue (a vertical axis) is displayed, and a user preference solution PS is highlighted.

In FIG. 20, the distribution is displayed for the total movement distance (the horizontal axis) and the distribution of the revenue (the vertical axis). The solution selection unit 106 is also capable of similarly displaying the distribution of other index values such as the total movement distance and the average of the vehicle occupation rate, the total movement distance and the number of operation plan change sites, and the total movement distance and the compatibility between the delivery company and the cargo owner.

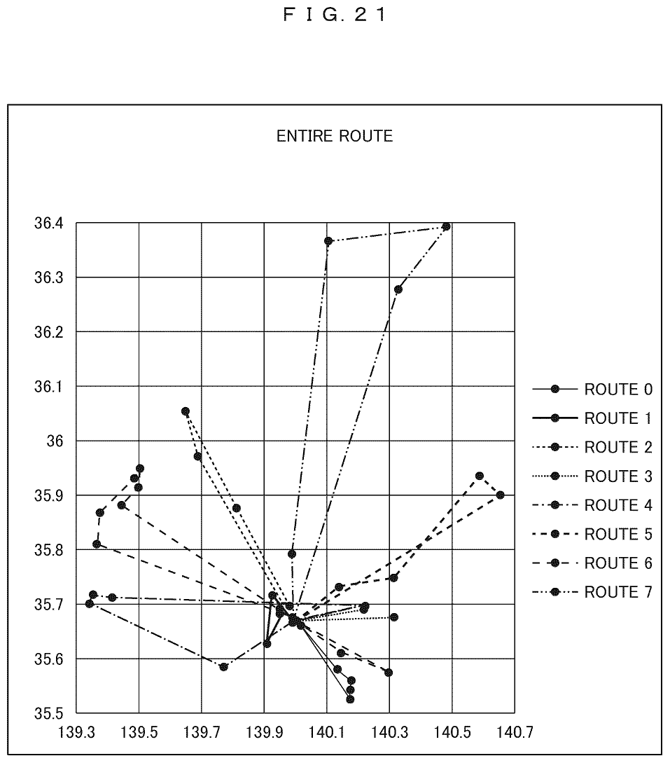

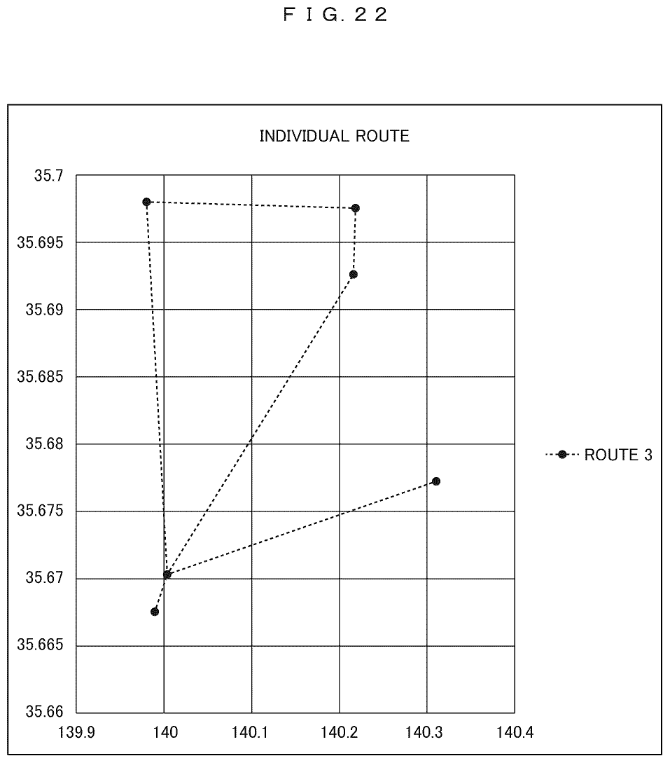

FIG. 21 and FIG. 22 are a diagram illustrating an example of the delivery route corresponding to the selected Pareto solution (user preference solution), output in step 1906. FIG. 21 illustrates an example of the patterns of all the delivery routes (the entire route) corresponding to the user preference solution, and FIG. 22 illustrates an example of the delivery route (the individual route) selected by the user from the delivery routes illustrated in FIG. 21.

The solution selection unit 106 reads out the delivery route corresponding to the user preference solution from the matched route data 1096, and displays the delivery route on the output device 1605. In FIG. 21, the pattern of the delivery route with the latitude on a vertical axis and the longitude on a horizontal axis is displayed in an identifiable manner. Here, it is illustrated that there are eight delivery routes of a route 0 to a route 7 corresponding to the user preference solution, and among them, the user selects the route 3.

As described above, for the user preference solution, as illustrated in FIG. 20, a relationship in each index value of the user preference solution is presented to the user in a visually recognizable manner, and thus, the user can easily check each index value of the Pareto solution selected by the user. In addition, as illustrated in FIGS. 21 and 22, the pattern of the delivery route of the user preference solution or the delivery route selected from the pattern are represented in a visually recognizable manner, and thus, the user can easily check the candidate of the delivery route of the Pareto solution selected by the user, or the actual position or route of the selected delivery route.

In a case where the processing illustrated in FIG. 19 is ended, the user preference solution selected by the user from the Pareto solutions presented as the recommended solution, or each index value or the delivery route corresponding to the user preference solution is output.

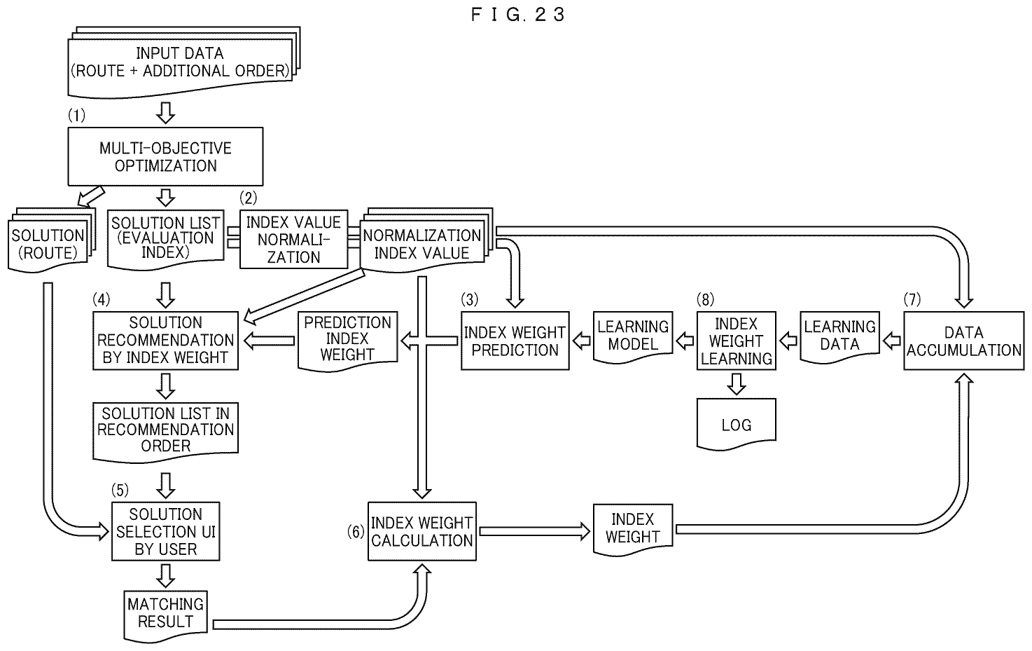

The delivery matching processing performed in this system has been described using each drawing after FIG. 13A, but the entire process of the delivery matching processing can be illustrated as a process flow illustrated in FIG. 23. That is, as illustrated in FIG. 23, in this system, first, (1) the multi-objective optimization unit 102 derives the solution set (the solution list) of the solution set index data 1097 of the Pareto solution between the indices with respect to the input data including the combination of the delivery route and the additional delivery order, and the matched route data 1096 that is the delivery route (the solution route) corresponding to each Pareto solution of the solution list. Then, (2) the index value normalization unit 103 outputs the normalization index value by normalizing the value of each index of each Pareto solution included in the solution list, and accumulates the normalization index value vector of which the component is the normalization index value in the learning data 1098.

Further, (3) the index weight prediction unit 104 inputs the normalization index value vector to the learned learning model learned by the index weight learning unit 108, and outputs the prediction index weight vector for each Pareto solution. Then, (4) the solution recommendation unit 105 outputs the recommended solution list in which the Pareto solution is sorted in the recommendation order, on the basis of the degree of cosine similarity between the normalization index value vector and the prediction index weight vector.

Then, (5) in a case where the Pareto solution desired by the user is selected as the user preference solution from the Pareto solutions of the recommended solution list, the solution selection unit 106 outputs information such as the delivery route, the index value distribution of the recommended solution, and the delivery route of the recommended solution to the output device 1605. Subsequently, (6) the index weight calculation unit 107 outputs the normalization index value vector of the training data that is the user preference solution from the Pareto solutions presented as the recommended solution, and feeds back and adds the normalization index value vector to the past learning data 1098.

Further, (7) the index weight learning unit 108 inputs the learning data 1098 that is accumulated by the index value normalization unit 103 and added by the index weight calculation unit 107 to update the learning model. Then, in (3), the index weight prediction unit 104 outputs the newest prediction index weight vector using the new learning model updated by the index weight learning unit 108.

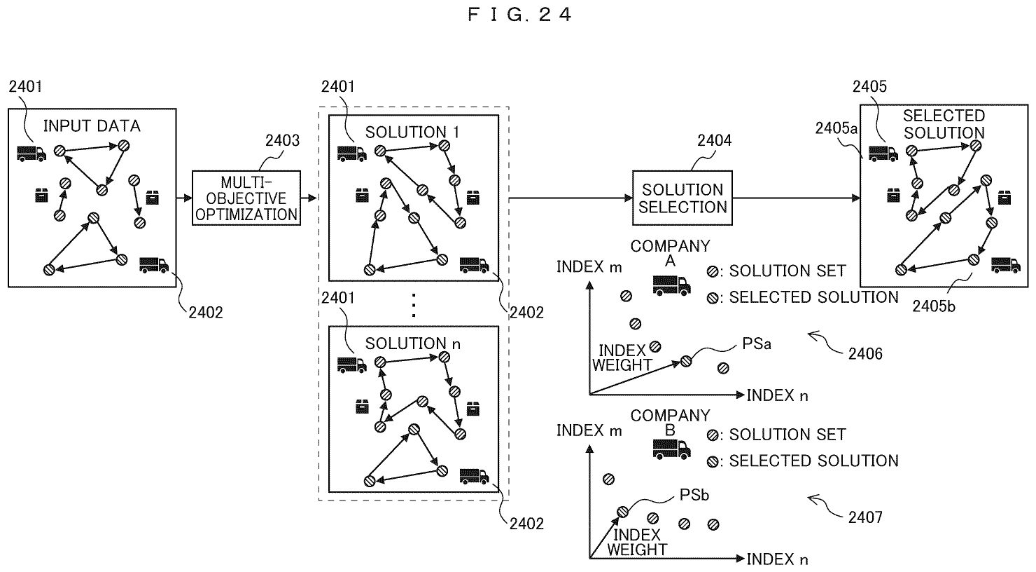

The delivery matching system in this example has been described, but it may be possible to select the Pareto solution that is matched with the preference of each delivery company considering a case where an index to be emphasized is different in accordance with a delivery company delivering a cargo. In this case, as illustrated in FIG. 24, first, the multi-objective optimization unit 102, for each delivery company, derives the solution set (the solution list) of the solution set index data 1097 of the Pareto solution between the indices, and the delivery route (the solution route) corresponding to each Pareto solution of the solution list, from input data including a combination of a delivery route and an additional delivery order for each delivery company. In this example, the multi-objective optimization unit 102 reads in a delivery route and an additional order of a company 2401 (a company A) and a delivery route and an additional order of a company 2402 (a company B) as the input data. The multi-objective optimization unit 102 performs the multi-objective optimization processing 2403 that has been described, and outputs the Pareto solution for each delivery company. In this example, Pareto solutions 1 to n for the companies A and B are output.

After that, for each delivery company, the normalization of each index value of each Pareto solution by the index value normalization unit 103, the calculation of the prediction index weight vector for each Pareto solution by the index weight prediction unit 104, and the output of the recommended solution list by the solution recommendation unit 105 are performed. Then, the solution selection unit 106 receives the selection of the user preference solution from the Pareto solutions. In this example, a selected solution 2405 is selected by solution selection 2404. The selected solution 2405 includes Pareto solutions 2405a and 2405b for each of the companies A and B. The Pareto solution 2405a is a user preference solution PSa in a solution set 2406 for each index, and the Pareto solution 2405b is a user preference solution PSb in a solution set 2407 for each index.

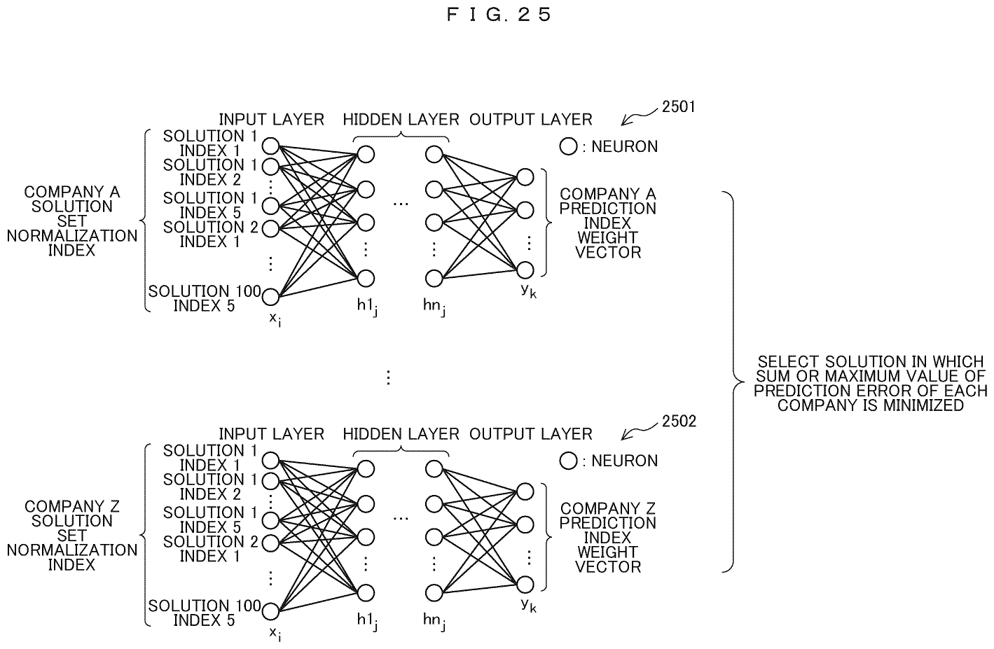

Then, for each delivery company for which the value is calculated, the index weight calculation unit 107 outputs a normalization index value vector for the selected user preference solution. Further, as illustrated in FIG. 25, the index weight learning unit 108, for each delivery company for which the index value is calculated, inputs the normalization index value of the Pareto solution output by the multi-objective optimization unit 102 to the learning model, and fits the prediction index weight vector output by the index weight prediction unit 104 such that a prediction error from the normalization index value of the training data that is the selected user preference solution is minimized. In FIG. 25, the normalization index value of the Pareto solution for a certain delivery company (the company A) is input to the learning model, and the prediction index weight vector of the company A is subjected to calculation 2501, the normalization index value of the Pareto solution for another delivery company (a company Z) is input to the learning model, and the prediction index weight vector of the company Z is subjected to the calculation 2501. Then, the index weight prediction unit 104 outputs the prediction index weight vector in which the sum of the prediction errors (or the maximum value of the prediction error) for each delivery company is minimized.

As described above, in consideration of a case where a delivery route crossing a plurality of delivery companies is formed, each index value is calculated for each delivery company, and the sum of a difference between the prediction index weight vector and the normalization vector for each company or the Pareto solution in which the maximum value of the prediction error is minimized is selected as the user preference solution. Accordingly, even in a case where the index to be emphasized is different in accordance with the delivery company, it is possible to select the Pareto solution that is matched with the preference of the delivery company.

As described above, the delivery matching system in this example, as described using FIGS. 1, 13, and the like, is the delivery matching system 1000 allocating the additional order for delivering the cargo to the existing delivery route by the computer 1600 including the processor and the memory, in which the processor performs the learning of the predetermined learning model (for example, a neural network or a decision tree) using the index value for the selected solution (the user preference solution), which is the Pareto solution selected by the user among the Pareto solutions based on the predetermined index (the indices 1 to 5 described above), obtained from the past input data including the combination of the delivery route and the additional delivery order, as the training data (for example, the index weight learning unit 108), inputs the current input data including the combination to the learned predetermined learning model, and calculates the prediction index weight vector for each index of the Pareto solution (for example, the index weight prediction unit 104), specifies the Pareto solution in which the degree of similarity with the prediction index weight vector satisfies the predetermined condition, among the Pareto solutions (for example, the degree of cosine similarity is the highest or a predetermined value or higher) (for example, the solution recommendation unit 105 and the solution selection unit 106), and outputs the specified Pareto solution (the solution selection unit 106 and the input and output unit 101). Accordingly, it is possible to select the user preference solution considering the index emphasized by the user, from the plurality of optimum solutions (Pareto solutions), in accordance with the distribution state of the index value, in the optimization calculation in a case where there are the plurality of indices. As a result thereof, it is possible to reduce a cost required for an operation in which the user selects the user preference solution from the plurality of optimum solutions.

In addition, as described using FIGS. 24, 25, and the like, the processor performs the learning of the predetermined learning model using the index value of the selected solution for each of the plurality of delivery companies (for example, the companies A and B) among the Pareto solutions for the plurality of delivery companies included in the past input data, as the training data, and inputs the input data including the plurality of delivery companies to the learning model, and calculates the prediction index weight vector for each delivery company. Accordingly, even in a case where the index to be emphasized is different in accordance with the delivery company, it is possible to select the Pareto solution that is matched with the preference of the delivery company.

In addition, as described using FIG. 3C and the like, the processor performs the machine learning by the neural network, as the learning by the predetermined learning model. Accordingly, it is possible to perform the machine learning by simple tuning.

In addition, as described using FIG. 18 and the like, the processor sorts and outputs the specified Pareto solution in descending order the degree of similarity. Accordingly, it is possible for the user to easily grasp the Pareto solution to be recommended.

In addition, FIG. 10, as described using Equations 1 to 5 and the like, the processor calculates, as the predetermined index, the Pareto solution based on the movement distance of the vehicle delivering the cargo, the distribution of the revenue indicating how evenly cargos are transported on the delivery route, the vehicle occupation rate indicating the ratio of the vehicle delivering the cargo, the compatibility with the delivery company indicating the ratio of the cargo owner requesting the specific delivery company for all the delivery companies, and the number of operation plan change sites indicating the number of sites at which the vehicle changes the operation plan for the delivery route in accordance with the additional order. Accordingly, it is possible to select the Pareto solution that is desired by the user as the user preference solution from the Pareto solution between indices.

In addition, as described using FIGS. 13B, 15, and the like, the processor accumulates the past and current input data and the Pareto solution for each user using this system, and switches the learning of the predetermined learning model and the calculation of the prediction index weight vector for each user. Accordingly, it is possible to switch the learning model in accordance with the user using this system, and present the recommended solution that is further matched with the preference of the user.

In addition, as described using FIG. 18A and the like, the processor changes the output position of the index value of the Pareto solution, in accordance with the superior or inferior relationship of the index value of the specified Pareto solution. Accordingly, it is possible for the user to easily grasp which index contributes to the order sorted as the recommended solution.

In addition, as described using FIG. 18B and the like, the processor sorts the Pareto solution, in accordance with the degree of priority of the index value of the specified Pareto solution. Accordingly, it is possible to sort the index selected by the user in descending order, and provide the environment in which the Pareto solution is more easily selected by the user.

In addition, as described using FIG. 20 and the like, the processor displays the distribution of each index value of the specified Pareto solution on the screen. Accordingly, it is possible to easily check each index value of the user preference solution selected by the user.

In addition, as described using FIGS. 21, 22, and the like, the processor displays the delivery route corresponding to the specified Pareto solution on the screen. Accordingly, it is possible to easily check the candidate of the delivery route of the user preference solution selected by the user, or the actual position or route of the delivery route.

In addition, as described using FIGS. 13A, 15A, and the like, the processor accumulates the past and current input data and the Pareto solution, and switches the learning of the predetermined learning model and the calculation of the prediction index weight vector, in accordance with the time until the delivery. In a case where this processing is performed at a timing when a certain amount of time or longer is secured until the delivery time (for example, before the previous day) and a case where this processing is performed at a timing close to the delivery time (for example, on the day), the index to be considered and the weight of the index differ. For example, in a case where the time until the delivery is short, the Pareto solution with the index that reduces the driver burden is often selected as the user preference solution, and thus, according to such a configuration, after considering the time constraint, it is possible to present the recommended solution that is matched with the preference of the user.

In addition, as described using FIG. 23 and the like, the processor feeds back and adds the index value for the selected solution selected by the user from the specified Pareto solutions to the index value of the Pareto solution based on the predetermined index, obtained from the past input data. Accordingly, it is possible to accumulate the learning data reflecting the index value of the user preference solution selected by the user in the past, and increase the learning accuracy.

The invention is not limited to the embodiment described above, and in the implementation stage, the constituents can be modified and embodied within a range not departing from the gist thereof, or a plurality of constituents disclosed in the embodiment described above can be implemented in a suitable combination.

What is claimed is:

1. A delivery matching system allocating an additional order for delivering a cargo to an existing delivery route by a computer including a processor and a memory,
wherein the processor
performs learning of a predetermined learning model using an index value for a selected solution, which is a Pareto solution selected by a user among Pareto solutions based on a predetermined index, obtained from past input data including a combination of a delivery route and an additional delivery order, as training data,
inputs current input data including the combination to the learned predetermined learning model, and calculates a prediction index weight vector for each index of the Pareto solution,
specifies a Pareto solution in which a degree of similarity with the prediction index weight vector satisfies a predetermined condition, among the Pareto solutions, and
outputs the specified Pareto solution.

2. The delivery matching system according to claim 1,
wherein the processor
performs the learning of the predetermined learning model using an index value of the selected solution for each of a plurality of delivery companies among the Pareto solutions for the plurality of delivery companies included in the past input data, as training data, and
inputs the input data including the plurality of delivery companies to the learning model, and calculates the prediction index weight vector for each of the delivery companies.

3. The delivery matching system according to claim 1,
wherein the processor
performs machine learning by a neural network, as learning by the predetermined learning model.

4. The delivery matching system according to claim 1,
wherein the processor
sorts and outputs the specified Pareto solution in descending order of the degree of similarity.

5. The delivery matching system according to claim 1,
wherein the processor
calculates, as the predetermined index, a Pareto solution based on a movement distance of a vehicle delivering the cargo, a distribution of revenue indicating how evenly cargos are transported on the delivery route, a vehicle occupation rate indicating a ratio of the vehicle delivering the cargo, compatibility with a delivery company indicating a ratio of a cargo owner requesting a specific delivery company for all delivery companies, and the number of operation plan change sites indicating the number of sites at which a vehicle changes an operation plan for a delivery route in accordance with an additional order.

6. The delivery matching system according to claim 1,
wherein the processor
accumulates the past and current input data and the Pareto solution for each user using the system, and
switches the learning of the predetermined learning model and the calculation of the prediction index weight vector for each user.

7. The delivery matching system according to claim 4,
wherein the processor
changes an output position of the index value of the Pareto solution, in accordance with a superior or inferior relationship of an index value of the specified Pareto solution.

8. The delivery matching system according to claim 4,
wherein the processor
sorts the Pareto solution, in accordance with a degree of priority of an index value of the specified Pareto solution.

9. The delivery matching system according to claim 4,
wherein the processor
displays a distribution of each index value of the specified Pareto solution on a screen.

10. The delivery matching system according to claim 4,
wherein the processor
displays a delivery route corresponding to the specified Pareto solution on a screen.

11. The delivery matching system according to claim 5,
wherein the processor
accumulates the past and current input data and the Pareto solution, and
switches the learning of the predetermined learning model and the calculation of the prediction index weight vector, in accordance with time until the delivery.

12. The delivery matching system according to claim 1,
wherein the processor
feeds back and adds an index value for the selected solution selected by the user from the specified Pareto solutions to the index value of the Pareto solution based on the predetermined index, obtained from the past input data.

13. A delivery matching method for a computer to allocate an additional order for delivering a cargo to an existing delivery route, the method comprising:
performing learning of a predetermined learning model using an index value for a selected solution, which is a Pareto solution among Pareto solutions based on a predetermined index, obtained from past input data including a combination of a delivery route and an additional delivery order, as training data;
inputting current input data including the combination to the learned predetermined learning model, and calculating a prediction index weight vector for each index of the Pareto solution;
specifying a Pareto solution in which a degree of similarity with the prediction index weight vector satisfies a predetermined condition, among the Pareto solutions; and
outputting the specified Pareto solution.
